(19) United States
(12) Patent Application Publication
(10) Pub. No.: US 2007/0036202 A1
(43) Pub. Date: Feb. 15, 2007

(54) Code, signal and conjugate direction design for rapidly-adaptive communication receivers and electromagnetic, acoustic and nuclear array processors

(76) Inventors: Hongya Ge, New Providence, NJ (US); Louis L. Scharf, Fort Collins, CO (US)

Correspondence Address: KAPLAN GILMAN GIBSON & DERNIER L.L.P., 900 ROUTE 9 NORTH, WOODBRIDGE, NJ, 07095, US

(21) Appl. No.: 11/374,485

(22) Filed: Mar. 13, 2006

Related U.S. Application Data
(60) Provisional application No. 60/660,960, filed on Mar. 11, 2005.

(51) Int. Cl. H04B 1/00

(52) U.S. Cl. 375/141

(57) ABSTRACT

A system and method are disclosed that substantially reduce the complexity of receivers in digitally modulated wireless communication systems such as systems that use CDMA and similar multi-access coding. Transmitted signals are designed to use orthogonal or non-orthogonal codes with specific amplitudes that reduce the number of distinct eigenvalues in a code correlation matrix or in a code-plus-interference-plus-noise correlation matrix, so that a few steps of a conjugate direction calculation will compute a reduced rank Wiener filter that can be used to provide approximate de-correlation type receivers in a substantially reduced number of steps when compared to inverse correlation matrix calculations, or when compared to conjugate direction computations run on correlation matrices with un-shaped eigenvalues. These techniques can also be applied to active or passive imaging systems such as sonar, ultrasound and radar imaging systems and phased array systems that use beam forming. Cancellation of interference and noise can also be accomplished by exploiting eigenvalue shape or by designing the codes and amplitudes of the transmitted signal and using the reduced rank Wiener filter to filter interference and noise from the receive signal. The techniques enable the use of code design and power control for the control of system complexity and bandwidth.

### CROSS-REFERENCE TO RELATED APPLICATION

This application claims benefit of and priority to U.S. Provisional Patent Application Ser. No. 60/660,960 entitled “Code, Signal and Conjugate Direction design for Rapidly-Adaptive Communication Receivers and Electromagnetic, Acoustic and Nuclear Array Processors”, filed Mar. 11, 2005, the entire contents of which are specifically incorporated herein by reference.

### STATEMENT REGARDING FEDERAL RIGHTS

This invention was made with government support under Contract No. N00014-04-1-0084 awarded by the Office of Naval Research; Contract Nos. CCR-0112573 and CCR-0085846 awarded by the National Science Foundation; and Contract No. F33615-02-C-1198 awarded by the Defense Advanced Research Projects Agency. The government may have certain rights in the invention.

### BACKGROUND OF THE INVENTION

The present invention pertains generally to signal processing systems for extracting signals from interference and noise, and more particularly to signal processing systems that extract digitally modulated signals from noise and interference induced during the transmission of such digitally modulated signals.

Channel and noise effects in communication and imaging systems introduced during the transmission of digitally modulated signals compel the use of signal processing and multivariate statistical inference for extracting useful information from filtered and noisy data. The principles used in the design of such systems utilize modeled or measured properties of the signals, interference, noise, and signal-plus-interference-plus-noise, to design matrix signal processors. Such matrix processors use matrix inversion or matrix eigen-analysis for multi-user separation and interference cancellation, for channel estimation and equalization, and for timing acquisition. These matrix processors are indicated in most, if not all, modern standards for wireless communication, including, but not limited to, CDMA, OFDM, GSM, and UWB, and in most, if not all, systems for beam forming, imaging, and detection in radar, sonar and medical imaging. The matrix calculations are extensive and time consuming. They add to the complexity of the signal processing and reduce the real-time or lab-time speed at which the signal processor can run and produce results.

### SUMMARY OF THE INVENTION

The present invention overcomes the disadvantages and limitations of the prior art by providing a multiple user communication system that is designed using resource management of spreading codes and power controls to reduce the number of distinct eigenvalues that would otherwise be created in the signal correlation matrix so that the conjugate direction calculations can be made in reduced rank Wiener filters to approximate de-correlation results in a substantially reduced number of steps (substantially equal to the reduced number of distinct eigenvalues) in comparison to inverse matrix calculations. The terminology de-correlation is used in a very general way, to include any matrix processor that uses a matrix inverse to design a receive filter.

The present invention may therefore comprise a method of designing a transmitter of a digital modulation communication system to simplify the process of extracting noise and interference from a received signal comprising: encoding an input for transmission in the digital modulation communication system with selected spreading codes to produce an encoded input; adjusting the amplitudes of the spreading codes to produce an encoded, weighted signal; the spreading codes and the amplitudes of the encoded input being selected so that the encoded, weighted signal has a correlation matrix with a designed number of distinct eigenvalues; receiving the digitally modulated signal; and filtering the encoded, weighted signal from noise and interference induced during transmission using a reduced-rank Wiener filter that approximates de-correlation results by using conjugate direction calculations that have a number of steps that is substantially equal to the designed number of distinct eigenvalues so that the number of steps of said conjugate direction calculations can be controlled by selection of the spreading codes and the amplitudes of the spreading codes.

The present invention may further comprise a method of providing noise and interference cancellation in a multi-user digital modulation communication system comprising: assigning symbols to a plurality of binary inputs from the multiple users; encoding the symbols with good spreading codes to create a plurality of encoded symbols; adjusting amplitudes of the encoded symbols to produce a plurality of encoded, weighted symbols such that the spreading codes used to encode the symbols and the amplitude of the encoded symbols cause a correlation matrix of the encoded, weighted symbols to have a designed number of distinct eigenvalues; digitally modulating the encoded, weighted symbols to produce a digitally modulated, encoded weighted signal; transmitting the digitally modulated, encoded weighted signal; receiving a detected signal having a digitally modulated, encoded weighted signal component and an interference and noise component; demodulating the detected signal; and filtering the detected signal to substantially remove the interference and noise component using a reduced-rank Wiener filter that approximates de-correlation results by using conjugate direction calculations that have a number of steps that is substantially equal to the designed number of distinct eigenvalues so that the number of steps of the conjugate direction calculations can be controlled by selection of the spreading codes and the amplitudes of the spreading codes.

The present invention may further comprise a method of canceling noise and interference in both passive and active scanning systems comprising: encoding an input signal of the active scanning system with good space-time codes and encoding symbols to create a good transmit signal; adjusting amplitudes of the plurality of encoding symbols to produce the space-time codes and the amplitudes of the encoding symbols so that the good transmit signal has a correlation matrix with a designed number of distinct eigenvalues; exploiting the small number of distinct eigenvalues in a passive system; generating a reduced-rank Wiener filter steering vector for beam forming, detection, or estimation, using a Wiener filter that approximates de-correlation results by using conjugate direction calculations that have a number of steps that is substantially equal to the designed and exploited number of distinct eigenvalues so that the number of steps of the conjugate direction calculations can be controlled in active scanning by selection of the good space-time codes and the amplitudes of the symbols, and exploited in passive scanning; and applying the reduced-rank Wiener filter steering vector to signals received by a space-time receiver of the scanning system to cancel interference and noise.

The advantages of the present invention are that information systems such as communication, radar, sonar, ultrasound, NMR, etc. can be designed using the techniques of the present invention to greatly reduce the complexity of these information systems. By reducing the complexity, reduced costs, higher speeds, and less expensive information systems can be provided, or systems of fixed complexity can be designed for higher bandwidth or larger multiuser capacity.

### BRIEF DESCRIPTION OF THE DRAWINGS

The foregoing and further objects features and advantages of the present invention will be understood more completely from the following detailed description of presently preferred, but nonetheless illustrative, embodiments in accordance with the present invention, with reference being had to the accompanying drawings, in which:

FIG. 1 is a schematic block diagram of an embodiment of a wireless communication system for providing noise and interference cancellation;

FIG. 2 is a schematic block diagram of another embodiment of a wireless communication system for providing noise and interference cancellation;

FIG. 3 is a schematic block diagram of an embodiment of a receiver that provides timing synchronization;

FIG. 4 is a schematic block diagram of another embodiment of a receiver that provides timing synchronization;

FIG. 5 is a schematic block diagram of an embodiment of a vector conjugate direction receiver with the number of steps controlled by eigenvalue shaping;

FIG. 6 is a schematic block diagram of an embodiment of an imaging system;

FIG. 7 is a schematic block diagram of a vector conjugate gradient calculation with the numbers of steps controlled by eigenvalue shaping;

FIG. 8 illustrates a matrix conjugate gradient calculation, with the number of steps controlled by eigenvalue shaping—in the preferred embodiment it converges in one step;

FIG. 9 is a schematic block diagram of a vector conjugate gradient reduced-rank Wiener filter with the number of steps controlled by eigenvalue shaping;

FIGS. 10 and 11 are performance charts useful in understanding the subject matter of the THEORY SECTION, Part A;

FIGS. 12 and 13 are performance charts useful in understanding the subject matter of the THEORY SECTION, Part B;

FIGS. 14-19 are charts useful in understanding the subject matter of the THEORY SECTION, Part C;

FIGS. 20 and 21 are performance charts useful in understanding the subject matter of the THEORY SECTION, Part D; and

FIGS. 22-25 are performance charts useful in understanding the subject matter of the THEORY SECTION, Part E.

(not used)

### DETAILED DESCRIPTION OF THE PREFERRED EMBODIMENTS

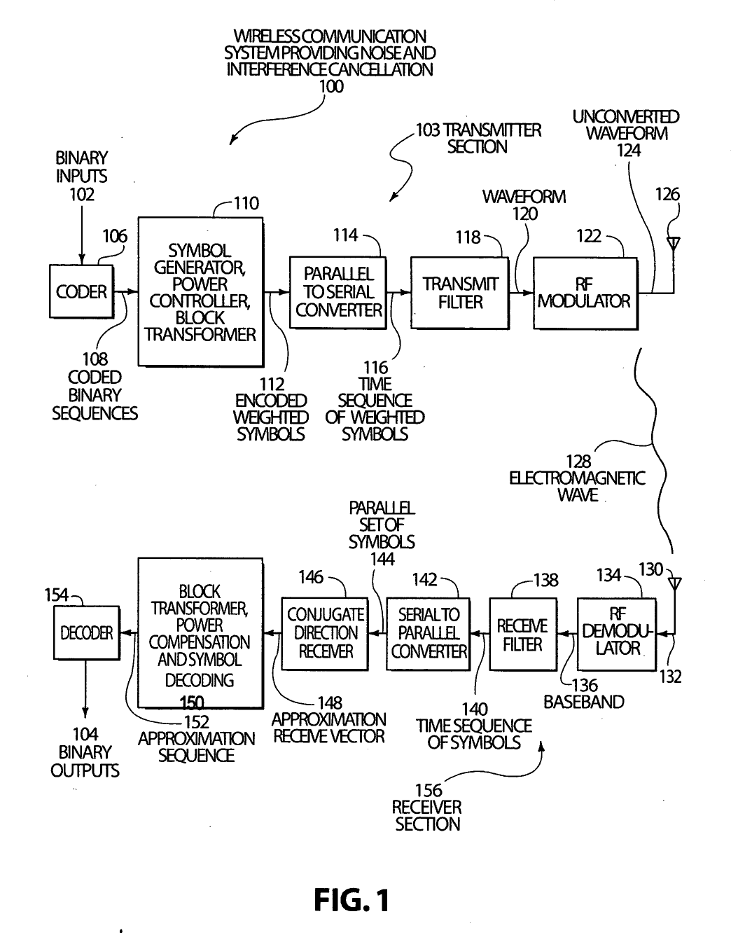

FIG. 1 illustrates an embodiment 100 of a wireless communication system providing noise and interference cancellation. System 100 includes a transmitter section 103 and a receiver section 156. Binary inputs 102, which can comprise multiple binary input strings from multiple users, are applied to a coder 106. Coder 106 can comprise a block coder, parity check coder, a finite state machine, or other such devices for processing ones and zeros in an input stream so as to create a respective coded binary stream in sequences 108. The coded binary sequences 108 are applied to a specifically designed block transform/symbol generator/power controller 110. Block 110, as indicated above, performs a number of functions. For example, each of the coded binary sequences 108 may be divided into groups of sequential bits, such that each group in each coded binary sequence encodes a different symbol, which is a complex number in a QAM constellation. The location of each symbol in the constellation can be represented in polar coordinates as a complex number, or in Cartesian coordinates with the axial (or real) component being the in-phase component and the ordinate (or imaginary) component being the quadrature component. The time interval used to transmit a symbol is called a baud interval.

As indicated above, the binary inputs 102 are from multiple users. So, for example, if there are 64 users, there may be 64 separate binary input sequences 102. After these inputs are coded in coder 106, in this example, there are 64 coded binary sequences 108 that are applied to block 110. For each baud interval, which has 64 inputs, a separate symbol (a) is generated for each block of user inputs. For each baud interval, a group of symbols (a) can be assembled as a vector. Block transform 110 assigns a separate code, such as a Walsh code or a Gold code, to each user symbol by generating a matrix to convert the sequence of symbol vectors to the corresponding Walsh or Gold codes to produce a sequence of Walsh encoded, or Gold encoded, symbols. Although Gold codes and Walsh codes are mentioned herein as examples of “spreading codes” that can be used in accordance with various embodiments disclosed herein, any set of spreading codes can be used that is capable of achieving correlation matrices with a small number of distinct eigenvalues, or with some other desired eigenvalue shaping.

In this manner, block 110 multiplies each symbol, in each baud period, for each user, by the corresponding Walsh or Gold code assigned to that user, and generates a series of a plurality of vectors in which each vector encodes a symbol (a) in a given baud interval for one of the different users. If there are less than or equal to 64 users and the spreading factor is 64, then the transmitted vector will be a 64-vector consisting of the sum of less than or equal to 64 vectors. This invention accommodates any integer number for the spreading factor and any number of users less than or equal to this number.

Another function of block 110 is to multiply each of the symbols and each of the encoding vectors by an amplitude (A), which can be thought of as weighting the symbols. This is accomplished by creating a diagonal matrix of amplitude values and performing a matrix multiplication with the transmitted vector. The assignment of the spreading codes, and the multiplication of each of these symbols by a specific amplitude, shapes the eigenvalues of the signal correlation matrix and affects the results of the de-correlation process. The number of distinct eigenvalues of the signal correlation matrix can be greatly reduced. For example, in the case of 64 different users, the number of distinct eigenvalues, without code design and power control, can be as large as 64. By designing the system, through the application of good codes such as Walsh or Gold codes, and applying an amplitude signal to each of the symbols, the number of distinct eigenvalues can be as low as one or two. Of course, in a standard inverse matrix de-correlation process with 64 users, there are 64 cubed steps required.

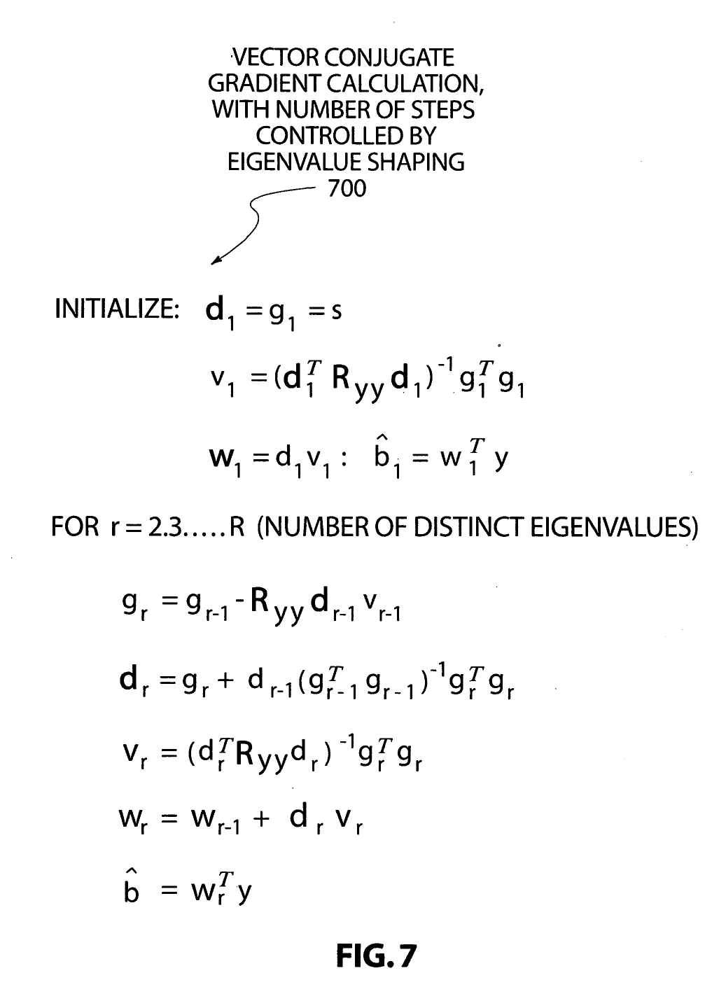

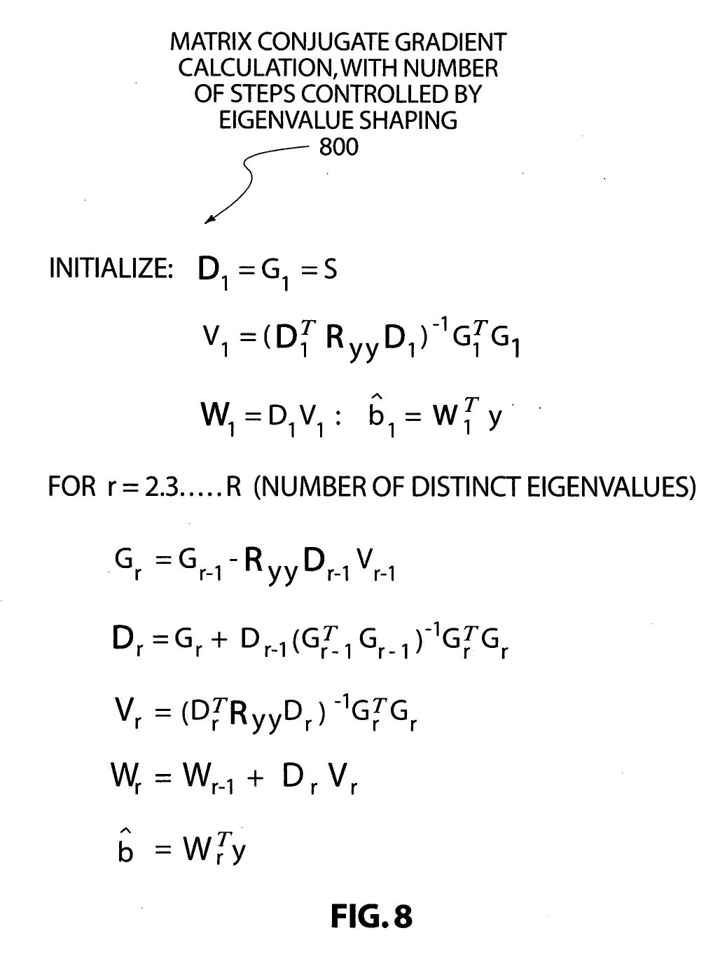

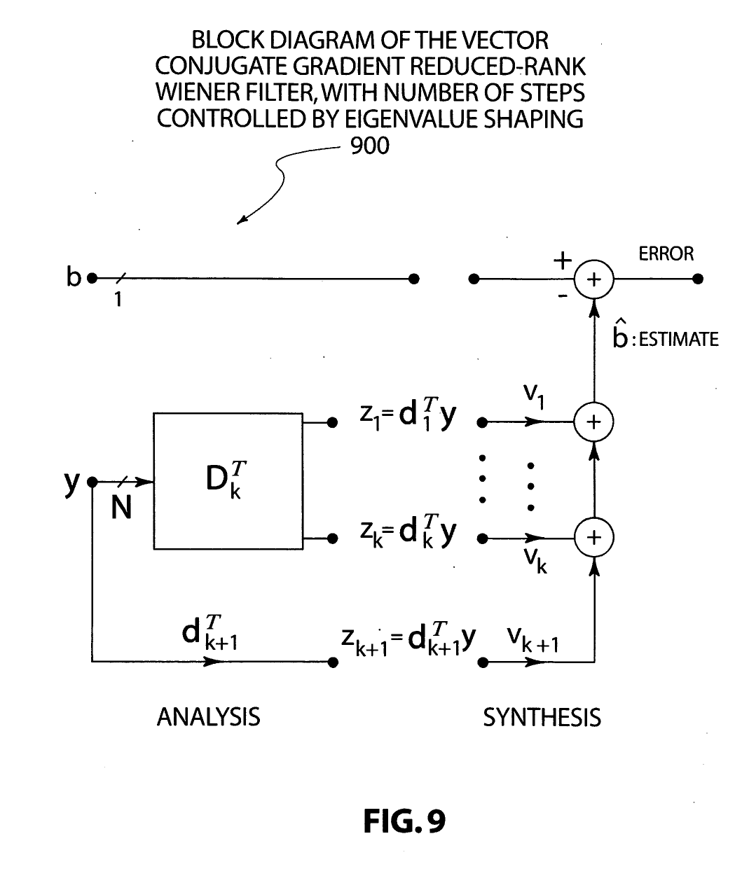

Conjugate direction calculation such as disclosed in FIGS. 7 and 8 using either vectors or matrices, respectively, can be made in reduced rank Wiener filters, such as shown in FIG. 9, to approximate the de-correlation results. However, the conjugate direction calculations can be done in a substantially reduced number of steps for properly designed systems that have a small number of distinct eigenvalues. The number of steps necessary for the conjugate direction calculations is substantially equal to the number of distinct eigenvalues. Hence, if the system is designed so that there are only two, for example, distinct eigenvalues, the number of steps required to approximate the de-correlation results using the conjugate direction calculations is substantially two.

As explained in more detail below, the conjugate direction receiver 146 can be made one to two orders of magnitude simpler by applying designed codes and amplitudes in block 110 to create an encoded, weighted signal 112 having correlation matrix with a small number of distinct eigenvalues. This is disclosed in more detail in the THEORY SECTION, Part A (below), entitled “Warp Converging Reduced-Rank Conjugate Gradient Wiener Filters for Multi-User Detection.” In addition, the THEORY SECTION, Part B, entitled “Warp Convergence in Conjugate Gradient Wiener Filters” discloses more details of the use of Gold codes.

As indicated above, specifically designing the encoded, weighted symbols 112 can also reduce the effects of interference through careful selection of the codes (see THEORY SECTION, Part B). By selecting codes in the presence of interference, such as multi-path interference, so that the codes remain good and maintain a small number of repeated eigenvalues in their correlation matrix, the effects of interference can be filtered in the reduced rank Wiener filter in a greatly reduced number of steps. In other words, the codes selected by the block transform in block 110 can be chosen so that the goodness of the code is not affected by interference. In this manner, the effects of interference can be minimized.

Selection of codes can be done empirically, or it can be accomplished in a feedback control system which detects the effects of interference and provides control signals to adjust the selection of codes in the block transform 110. A feedback control signal can also be used to modify the amplitude (A) matrix. Even with imperfect control of codes and amplitudes, the resulting signal correlation matrix will have eigenvalues clustered around a few distinct values, and the invention disclosed here will have the desired properties of rapid convergence.

The encoded weighted symbols 112 generated by block transform 110 are applied to a parallel to serial converter 114. The parallel to serial converter 114 generates a time sequence of the weighted and spread symbols in a serial stream 116. The stream 116 is then applied to a transmit filter 118. Transmit filter 118 is a standard transmit filter that convolves the time sequence of weighted and spread symbols with a waveform (g). The waveform 120 generated by the transmit filter 118 is applied to an RF modulator 122 that upconverts the waveform 120 to a desired carrier frequency. The upconverted waveform 124 is then applied to an antenna 126 for wireless transmission via an electromagnetic wave 128. Of course, the embodiment shown in FIG. 1, as well as the other embodiments disclosed herein, can be used in conjunction with any type of transmission that creates channel effects, noise and interference, and is not limited to wireless transmission. For example, such channel effects are known to exist in cable and twisted pair transmissions.

The electromagnetic wave 128 is received by the antenna 130 in the receiver section 156 of the embodiment of the wireless communication system 100. The electromagnetic wave 128, which is detected by the antenna 130, is transmitted as an electrical signal 132 to the RF demodulator 134. The RF demodulator 134 downconverts the receiver signal to a baseband signal 136. The baseband signal 136 is applied to a receive filter 138. The receive filter 138 can be matched to the transmit filter 118, or to the convolution of the transmit filter and the channel impulse response. The output 140 of the receive filter 138 therefore constitutes a discrete-time sequence (d) that includes noise and interference introduced in the transmit channel. The serial to parallel converter 142 receives the discrete-time sequence 140 and converts sequence 140 to a parallel sequence of symbols 144. The parallel sequence of symbols 144 is then applied to the conjugate direction receiver 146.

The conjugate direction receiver 146, that is illustrated in FIG. 1, performs the vector conjugate gradient calculations 800 illustrated in FIG. 7. If the receiver section 156 forms a part of a base station, and the parallel set of symbols 144 constitutes symbols from multiple users, the conjugate direction receiver 146 may perform the matrix conjugate gradient calculation 900 illustrated in FIG. 8. If only one user is to be decoded, as in a wireless handset, then the vector conjugate direction calculation of FIG. 7 may be used. The conjugate direction receiver 146 is capable of providing approximate de-correlation results with a substantially reduced number of steps in comparison to inverse matrix calculations as a result of a small number of distinct eigenvalues in the correlation matrix for the symbol vector 144, which is a consequence of the design provided by block 110. Hence, the outputs 148 of the conjugate direction receiver 146 are approximation vectors 148 in which there has been a substantial cancellation of noise and interference. The approximation vector 148 is applied to the block transform 150, which essentially performs the inverse of block 110 to produce a coded binary sequence 152. The coded binary sequence 152 is applied to decoder 154 to produce binary outputs 104.

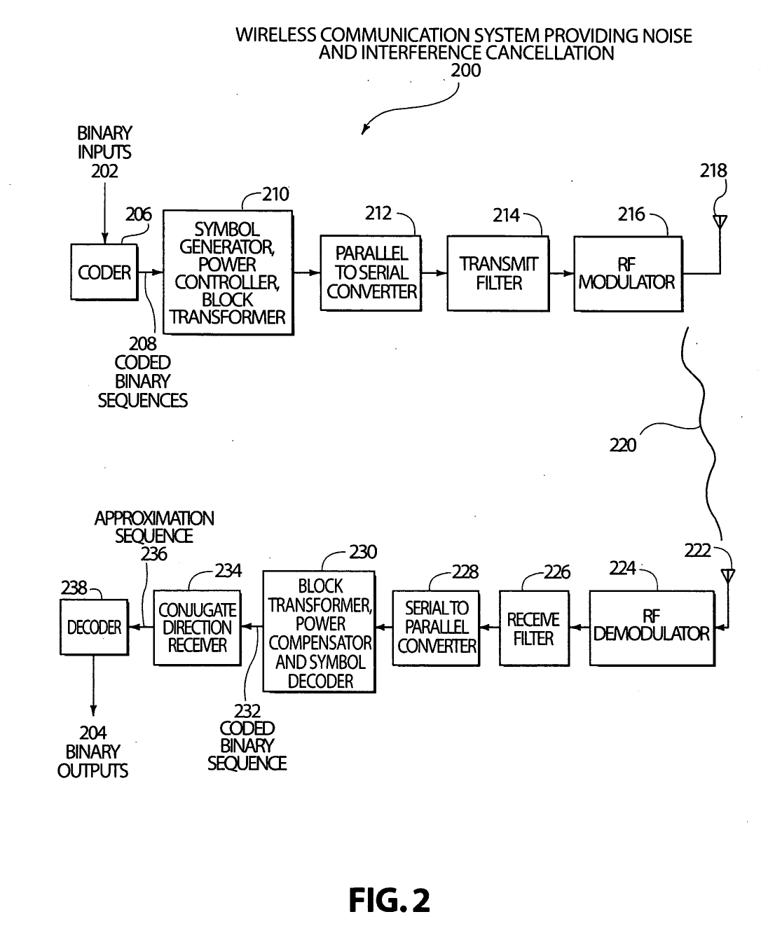

FIG. 2 illustrates another embodiment of a wireless communication system 200 providing noise and interference cancellation. As shown in FIG. 2, binary inputs 202 are applied to the coder 206. The coder generates a coded binary sequence 208 that is applied to the specifically designed block transform/symbol generator/power controller 210. Block transformer 210 operates in the same manner as block transformer 110 of FIG. 1. The output of a block transformer 210 is applied to the parallel to serial converter 212, which in turn provides an output to transmit filter 214, which in turn provides an output to RF modulator 216, all of which operate in the same manner as the corresponding system elements illustrated in FIG. 1. The output of the RF modulator 216 is applied to an antenna 218 that transmits an electromagnetic wave 220.

The electromagnetic wave 220 is received at an antenna 222, which is provided to the RF modulator 224. The RF modulator 224 downconverts the signal to a baseband signal which is applied to a receive filter 226. The receive filter 226 can operate in the same manner as receiver filter 138 illustrated in FIG. 1. The output of the receive filter 226 is applied to the serial to parallel converter 228 which operates in the same fashion as serial to parallel converter 142. The output of the serial to parallel converter 228 is applied to the block transform 230. The output 232 of the block transform is an approximation sequence that is applied to the conjugate direction receiver 234. The conjugate direction receiver 234 operates in a fashion similar to the conjugate direction receiver 146 and generates an output 236 that is a coded binary sequence. The coded binary sequence 236 is applied to the decoder 238 which decodes the coded binary sequence 236 to produce the binary outputs 204. Further, the conjugate direction receiver 234 that is illustrated in FIG. 2 can perform the operations illustrated in either FIG. 7 or FIG. 8, and has a structure that is shown in FIG. 9.

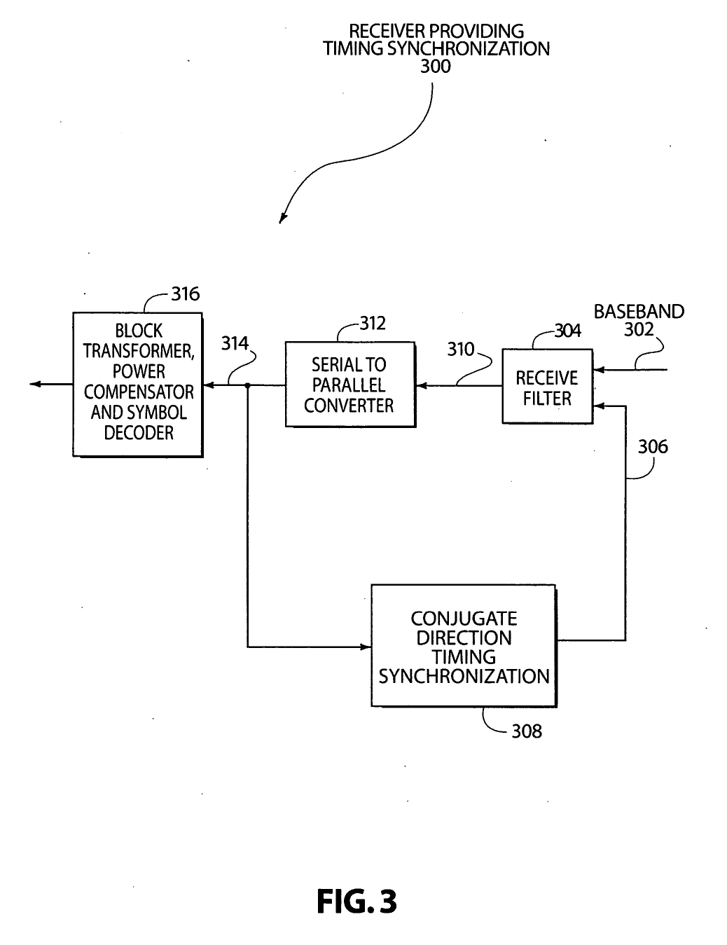

FIG. 3 illustrates an embodiment of a receiver 300, a modified version of receiver 156, that provides timing synchronization to receive filter 304. As shown in FIG. 3, the receive filter 304 can constitute any one of the receive filters shown in the embodiments of FIGS. 1 and 2, such as receive filters 138 and 226 respectively. The baseband signal 302 is applied to receive filter 304 which generates a time sequence of symbols 310 that is applied to the serial to parallel converter 312. The serial to parallel converter 312 generates a parallel set of symbols 314 that is applied to the block transformer 316 and to the conjugate direction timing synchronization device 308. Since the baseband signal 302 is a time-domain signal, the receive filter may become temporally misaligned with the baud interval of the data. The THEORY SECTION, Part C, entitled “Rank Reduction for Rapid Timing Acquisition in Multiple Access Communications,” discloses the manner in which the conjugate direction timing synchronization device 308 operates. Equation 22 thereof illustrates the manner in which the ratio of quadratic forms can be computed and maximized with a reduced rank Wiener filter. The output 306 of the conjugate direction timing synchronization device 308 is fed back to the receive filter 304 to adjust the timing of the receive filter 304.

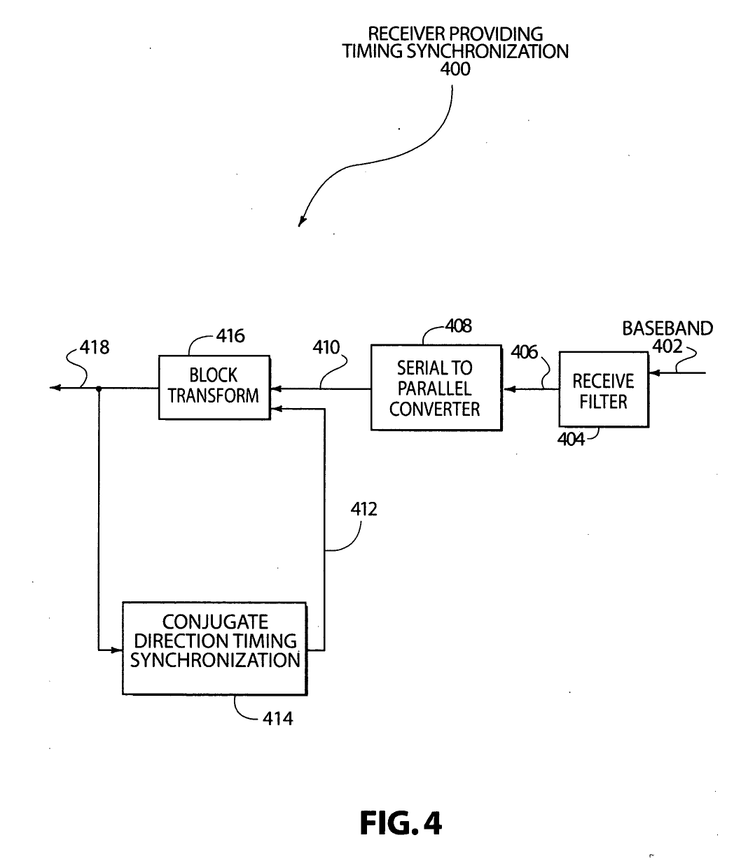

FIG. 4 is another embodiment of a receiver 400, a modified version of receiver 156, which provides timing synchronization for the block transform 416. As shown in FIG. 4, the baseband signal 402 is applied to the receive filter 404 which generates a time sequence of signals 406 that is applied to the serial to parallel converter 408. The parallel set of signals 410 is applied to the block transform 416. The coding sequence or the coded binary sequence 418 at the output of the block transform 416 is applied to the conjugate direction timing synchronization device 414. The conjugate direction timing synchronization device 414 operates in the manner described in the THEORY SECTION, Part C, entitled “Rank Reduction for Rapid Timing Acquisition in Multiple Access Communications.” A timing control signal 412 generated by the conjugate direction timing synchronization device 414 is applied to the block transform 416 to adjust the timing of the block transform 416.

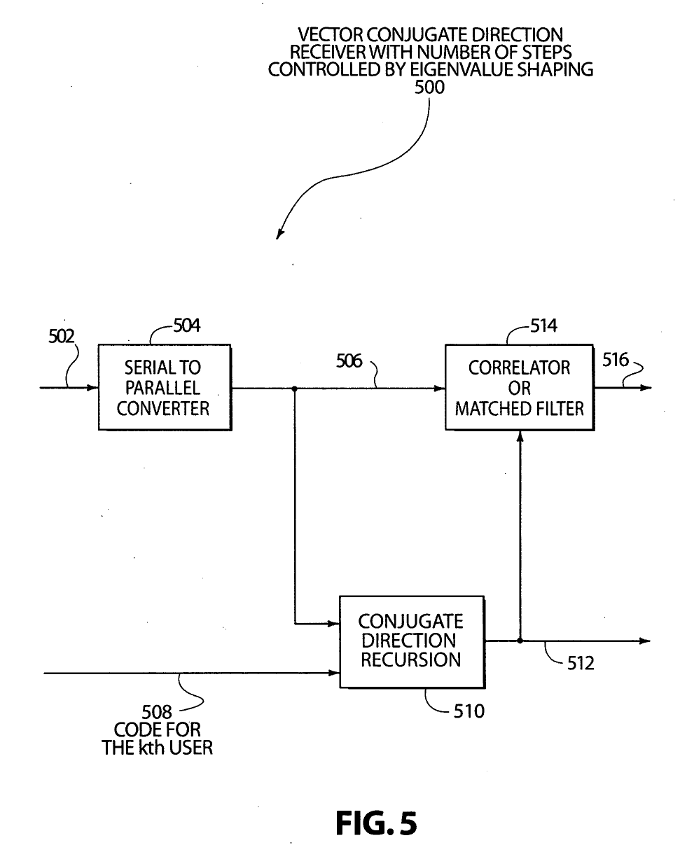

FIG. 5 illustrates an embodiment of a vector conjugate direction receiver 500 with a number of steps controlled by the eigenvalue shaping. The implementation of the vector conjugate direction receiver 500 comprises an implementation such as shown in FIG. 1 with blocks 142 and 146 substituted. As shown in FIG. 5, a time sequence of symbols 502 is applied to the serial to parallel converter 504. The output 506 of the serial to parallel converter is a parallel set of symbols that is applied to both the conjugate direction recursion device 510 and to the correlator or matched filter 514. The particular code 508 that is assigned to this particular user of this receiver is also applied to the conjugate direction recursion device 510. The conjugate direction recursion device 510 performs the steps illustrated in FIG. 7 and FIG. 8, which are recursions for computing the reduced rank filter w_{R} (a vector in FIG. 7) or W_{R} (a matrix in FIG. 8). The recursion is initialized by specifying the values of the direction vector d₁, the gradient vector g₁, and the step-size v₁. From this initialization, the conjugate gradient computation updates these values R−1 times to produce a sequence of direction vectors and step sizes that build the final filter w_{R}. The vector is output 512. The required inputs to the recursion are the correlation matrix R_{yy} and the code vector or correlation vector s. The correlation matrix is computed from received vectors using any of the standard methods of statistical and adaptive signal processing. The output 512 defines the correlator or matched filter 514 that processes received vectors.

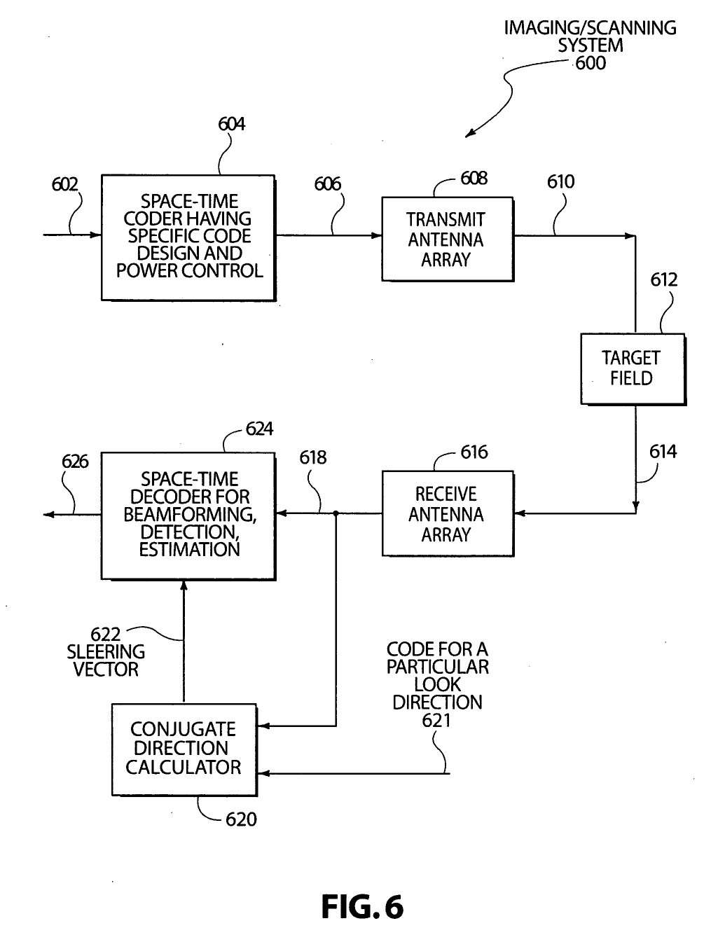

FIG. 6 is an embodiment of an imaging system 600 that incorporates novel features of the present invention. The system 600 of FIG. 6 is applied to radar, sonar, and or ultrasound processing and especially beam forming which necessitates the calculation of inverse matrices to remove noise and interference. This is disclosed in more detail in the THEORY SECTION, Part D, entitled “Warp Convergence in Conjugate Direction Wiener Filters.” As shown in FIG. 6, an input signal 602 is applied to the space-time coder that has a specific code design and power control to control eigenvalue shaping of the transmitted signal correlation matrix. The output 606 of space-time coder 604 is applied to a transmit antenna array 608. The array may constitute a phased antenna array, a sonar array, an ultrasound array, a nuclear magnetic resonance array or other similar types of arrays. The output 610 is applied to the target field 612 to be imaged. The reflected signal 614 from the target field 612 is detected by the receive antenna array 616. The receive antenna array 616 generates an electrical signal 618 that is applied to the space-time decoder 624 and to the conjugate direction calculator 620 to compute a reduced-rank Wiener filter steering vector w_{R} for beam forming, detection, or estimation.

A code 621 for a particular look direction is also applied to the conjugate direction calculator. The functions of the conjugate direction calculator 620 are disclosed in more detail in the THEORY SECTION, Part D, Section 3.2, “Application and Array Signal Processing.” The conjugate direction calculator 620 generates a reduced-rank Wiener filter steering vector 622 that is applied to space-time decoder 624 applies the steering vector 622 to cancel interference and noise from signal 618 using beam forming, detection, or estimation to generate image output 626 for beam forming detection, or estimation, in which noise and interference are substantially cancelled. As described in the THEORY SECTION, Part D, the calculations performed by the conjugate calculator 620 are greatly simplified because the reduced number of eigenvalues in the transmitted signal. In another embodiment of the invention, no signal is transmitted as the receiver passively listens for radiated signals. The disclosure of the THEORY SECTION, Part D shows that radiated signals typically have correlation matrices with special eigenvalue shaping so that the concepts disclosed herein can be utilized.

FIG. 9 is a block diagram description for a hardware or software implementation of the filter vector that is designed in FIG. 7 or the filter matrix that is designed in FIG. 8. Such an implementation may or may not be used, and other implementations are considered to be within the scope of the invention. The implementation shown in FIG. 9 is discussed in more detail in the THEORY SECTION, Part A, subsection III.

The THEORY SECTION, Part E, entitled “Reduced-Rank Filtering: Complexity and Performance Scalable Multiuser Detectors for Multi-Rate CDMA Systems,” discloses additional implementations of the conjugate direction filter. This section discloses the manner in which the conjugate direction filter operates with mixed rate signals in which longer codes are being used by some users, while other users are using shorter codes.

The present invention therefore provides an unique method of designing information systems, such as communication systems and imaging systems, to produce approximate de-correlation results with substantially reduced complexity, in comparison to inverse correlation matrix calculations. As a result, receivers can be constructed with substantially less complexity at less cost and easily operate at higher speeds. Systems can be designed with spreading codes and amplitudes such that the signal correlation matrix has only a very few distinct eigenvalues. The reduced rank Wiener filter rapidly converges to provide approximate de-correlation results in a number of steps substantially equal to the number of distinct eigenvalues. Hence, eigenvalue shaping of the transmitted signal allows fast convergence of the reduced rank Wiener-filter to substantially reduce the complexity of the receiver. In applications where no design is required to achieve the desired eigenvalue shaping, the invention exploits eigenvalue shaping that exists.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

### Theory Section

Part A—Warp Converging Reduced-Rank Conjugate Gradient Wiener Filters for Multiuser Detection

### I. Introduction

Many signal processing problems, ranging from signal detection to interference suppression to beamforming and array signal processing, involve the filtering operation s^{T}R_{yy}⁻¹y. For example, in CDMA systems, the measurement y is a vector of samples from the chip matched filter outputs, containing information from all active users, the matrix R_{yy} is the correlation matrix of such a data vector, and the vector s is the signature code of a desired user.

In a synchronous CDMA system, the real-valued data vector yεR^{N}, obtained in one symbol interval, can be modeled as

$$y = {\sum }_{k = 1}^{K} {A}_{k} {b}_{k} {s}_{k} + n = SAb + n , \qquad ( 1 )$$

where K is the number of active users in the system. The matrix A=diag{A₁, A₂, . . . , A_{K}} contains the users' amplitudes; the N×K matrix S=[s₁ s₂ . . . S_{K}] contains the K linearly independent users' signature vectors (normalized spreading codes); and the vector b=[b₁ b₂ . . . b_{K}]^{T} contains the independent BPSK symbols from all users. The real-valued white noise vector, n˜N(0, σ²I), is assumed Gaussian distributed.

Under equation (1), the data correlation matrix, the cross-correlation matrix between the data vector and the symbols from all users, and the cross-correlation vector between the data and a desired user (say user k) all have the structures,
R_{yy}=E{yy^{T}}=SA²S^{T}+σ²I,R_{yb}=E{yb^{T}}=SA,R_{yb}_{ₖ}=E{ybₖ}=Aₖsₖ, (2)
where the fact that E{b}=0 and E{bb^{T}}=I is used. It is well known that the linear MMSE (LMMSE, also the Wiener filter) multiuser detector (MUD) is optimum among all linear detectors, in terms of maximizing the output signal to interference-plus-noise ratio (SINR) or minimizing the mean square error (MSE). The decision rule for the LMMSE MUD is as follows: centralized decision for all K users:
\hat{b}=sgn{AS^{T}R_{yy}⁻¹y}=sgn{S^{T}R_{yy}⁻¹y}, (3)
decentralized decision for a desired user k (k=1, . . . , K):
\hat{b}ₖ=sgn{Aₖsₖ^{T}R_{yy}⁻¹y}=sgn{sₖ^{T}R_{yy}⁻¹y}. (4)
Note that, from the right-hand-most equalities above, the decision rules are invariant to positive scaling by the diagonal amplitude matrix A or scalar Aₖ for a BPSK modulation.

In practical systems, the high dimensionality of the received vector y often makes direct evaluation of the decision statistics in equations (3) and (4) unrealistic. First, with increasing dimensionality N, complexity associated with matrix inversion is of vital concern. Second, for a realistic scenario in which the statistics are not completely known beforehand but rather have to be estimated from data, there is a conflict between the dimension of R_{yy} and the number of measurements required for estimating the full rank R_{yy}. These design constraints commonly lead to situations in which low-complexity, reduced-rank approximations to the decision statistics of (3) and (4) are required. In this paper, we study two conjugate gradient (CG) reduced-rank Wiener filters: the matrix conjugate gradient for decoding all users in one shot, and the vector conjugate gradient for decoding each user one at a time. We prove several new convergence results for MUD in CDMA systems by exploiting the idea of expanding Krylov subspaces and the nature of invariant subspaces of reduced dimension. The results indicate that for many commonly encountered systems, the “full-rank” performance can be achieved by a “reduced-rank” receiver with a complexity only slightly higher than the matched filter or correlation receiver.

It was not until the work of Goldstein, et. al. [1], and its subsequent connection to conjugate gradients [2], that researchers in communication and signal processing understood the connection between filter design and optimization theory. We take this connection to be now known, and aim in this paper to establish that the convergence of conjugate gradient methods is actually dramatically faster than previously thought, for designed systems like CDMA systems.

### II. Connection to Conjugate Gradient Method

The conjugate gradient method, first introduced by Hestenes and Stiefel [3], was developed for iteratively solving quadratic minimization problems. The objective function to be minimized can be formulated as

$$J ( w ) = \frac{1}{2} {w}^{T} Rw - {s}^{T} w + constant , \qquad ( 5 )$$

where the vector w stands for an N-tuple of real-valued variables; the N-tuple s stands for a pre-selected known vector; and the N×N matrix R is symmetric and positive definite. The solution to this quadratic minimization problem is

$$w = arg {min}_{w} J ( w ) = {R}^{- 1} s . \qquad ( 6 )$$

In designing a linear MUD for a desired user, say user 1 with signature vector s₁, the expression for the mean squared error (MSE) of estimating b₁ from the real-valued synchronous CDMA data in equation (1) falls into the class of problems in (5). Specifically, we have

$$\begin{matrix}MSE ( {\hat{b}}_{1} ) {=}^{Δ} E \{ {\vert {b}_{1} - {w}^{T} y \vert}^{2} \} = 1 - {A}_{1} {s}_{1}^{T} w - {A}_{1} {w}^{T} {s}_{1} + {w}^{T} {R}_{yy} w , \\ = MMSE ( {\hat{b}}_{1} ) + {( {R}_{yy} w - {A}_{1} {s}_{1} )}^{T} {R}_{yy}^{- 1} ( {R}_{yy} w - {A}_{1} {s}_{1} ) , \\ = MMSE ( {\hat{b}}_{1} ) + {{A}_{1}^{2} ( {R}_{yy} {w}_{N} - {s}_{1} )}^{T} {R}_{yy}^{- 1} ( {R}_{yy} {w}_{N} - {s}_{1} ) ,\end{matrix} \qquad ( 7 )$$

where w stands for the filter vector and w_{N}=w/A₁ is its scaled version; and σ_{b}_{₁}²=1 for BPSK modulation. The minimum MSE
MMSE(\hat{b}₁)=1−A₁²s₁^{T}R_{yy}⁻¹s₁,
is achieved when the filter is chosen as the Wiener filter wₒₚₜ=A₁R_{yy}⁻¹s₁ or its scaled version w_{N,opt}=R_{yy}⁻¹s₁.

We note that the decision rule in equation (4) and performance measures such as the SINR and the bit error rate (BER) will not be affected by omitting the positive scalar A₁ in the Wiener solution. This invariance property can be observed from the decision rule in (4) and from the expressions for SINR and BER [4]. The SINR for a desired user (say user 1) is

$${SINR}_{1} = {A}_{1}^{2} \frac{{w}^{T} {s}_{1} {s}_{1}^{T} w}{{w}^{T} {R}_{I} w} , \qquad ( 8 )$$

which is invariant to non-zero scaling on w. Here,

$${R}_{I} = {\sum }_{k = 2}^{K} {A}_{k}^{2} {s}_{k} {s}_{k}^{T} + {σ}^{2} I ,$$

is the correlation matrix due to multiple access interference (MAI) and noise. The maximum SINR, which is related to the minimum MSE, is achieved when the Wiener filter wₒₚₜ is used:

$$max \{ {SINR}_{1} \} = {A}_{1}^{2} {s}_{1}^{T} {R}_{I}^{- 1} {s}_{1} = \frac{1}{MMSE ( {\hat{b}}_{1} )} - 1.$$

The BER (see [4], [5] for details) for the desired user (user 1) is

$${P}_{e} ( 1 ) = {E}_{b} \{ Q ( \frac{{A}_{1} - {b}_{1} {σ}^{2} {w}^{T} {A}^{- 1} b}{σ \sqrt{{w}^{T} {S}^{T} Sw}} ) \} \approx Q ( \sqrt{{SINR}_{1}} ) , \qquad ( 9 )$$

which is invariant to positive scaling of w. Here

$$Q ( x ) = {\int }_{x}^{∞} \frac{1}{\sqrt{2 π}} {ⅇ}^{- {t}^{2} / 2} ⅆ t$$

is the Gaussian tail probability.

Note that the expressions for SINR in (8) and the approximate BER (as a function of SINR) in (9) apply to any linear filter w, whether or not it is a full or reduced-rank Wiener filter. When the optimal linear filter (full-rank Wiener filter wₒₚₜ or its scaled version w_{N,opt}) is used, we reach the upper bound in SINR and the lower bound on the BER for linear receivers. As mentioned earlier, the “full-rank” solution is not practical for many real-time adaptive systems of large dimension. Hence, in the sequel, we will focus on different methods for efficiently computing the reduced-rank approximation, wₖ, to the scaled full-rank Wiener solution W_{NWF}=R_{yy}⁻¹s₁. Here, computationally efficient methods refer to iterative procedures for approximating R_{yy}w=s₁ without using matrix inversion and/or eigen-decomposition. A reduced-rank solution is especially important for adaptive MUD for CDMA systems involving large spreading gains N in dynamically changing wireless environments.

### III. Vector Conjugate Gradient Based Reduced-Rank Wiener Filter

Using the vector conjugate gradient (V-CG) method (with zero for the initial filter vector w₀=0), we start with an initial search direction d₁=g₁. The vector g₁=s₁−R_{yy}w₀ is the initial residue vector (negative gradient). During the iterative refinement stages, a rank-k approximation to the Wiener filter is formed, using the conjugate direction vectors generated by the V-CG method, as
wₖ=wₖ₋₁+αₖdₖ, (10)
where the step size αₖ=∥gₖ∥²/dₖ^{T}R_{yy}dₖ is chosen to optimize the step in direction dₖ. Subsequent search directions are chosen as the R_{yy}-conjugate directions

$${d}_{k + 1} = {g}_{k + 1} + \frac{{‖ {g}_{k + 1} ‖}^{2}}{{‖ {g}_{k} ‖}^{2}} {d}_{k} , \qquad ( 11 )$$

where dₖ^{T} R_{yy}dₘ=0 for k≠m. The residue vector is updated accordingly as
gₖ₊₁=s₁−R_{yy}wₖ=gₖ−αₖR_{yy}dₖ, (12)
where the first equation may have numerical advantage, while the second equation may have some computational and storage advantage. The choice of conjugate direction vectors dₖ decorrelates the internal variables, zₖ=dₖ^{T}y, in the recursion and alleviates the oscillating slow convergence commonly observed in the simple steepest descent algorithms. Note that the step size coefficients can be further simplified as αₖ=s₁^{T}dₖ/dₖ^{T}R_{yy}dₖ, which are simply the scalar Wiener filters working on the decorrelated internal variables zₖ.

We point out that there mainly exist two different ways to decorrelate the internal variables, zₖ=Tₖ^{T}y, during the reduced rank pre-processing of data y, namely the eigen-subspace approach (choosing columns of Tₖ=[u₁ u₂ . . . uₖ] as the eigenvectors of R_{yy}) and the Krylov-subspace approach (choosing columns of Tₖ=[d₁ d₂ . . . dₖ] as the R_{yy}-conjugate direction vectors). Examples of the eigen-subspace approach are the principal component (PC) [6] and the cross-spectral metric (CSM) methods [7]. Examples of the Krylov subspace approach are the conjugate gradient (CG), the conjugate direction (CD), and multistage Wiener filter (MSWF) methods [1], [2]. The mean squared error (MSE) expressions for the full-rank Wiener filter, the rank-k conjugate gradient (CG) Wiener filter, and the rank-k cross-spectral metric (CSM) Wiener filter for estimating b, from data y in (1) are summarized as [8], [9]

$$\begin{matrix}The full \text{-} rank WF \text{:} & MSE ( {b}_{1}^{( Full - WF )} ) = 1 - {A}_{1}^{2} {s}_{1}^{T} {R}_{yy}^{- 1} {s}_{1} \\ The rank \text{-} k CG WF \text{:} & MSE ( {b}_{1}^{( CG - WF )} ) = 1 - {A}_{1}^{2} {\sum }_{l = 1}^{k} \frac{{\vert {s}_{1}^{T} {d}_{l} \vert}^{2}}{{d}_{l}^{T} {R}_{yy} {d}_{l}} \\ The rank \text{-} k CSM WF \text{:} & MSE ( {b}_{1}^{( CSM - WF )} ) = 1 - {A}_{1}^{2} {\sum }_{l = 1}^{k} \frac{{\vert {s}_{1}^{T} {u}_{l} \vert}^{2}}{{λ}_{l}}\end{matrix} \qquad ( 13 )$$

where the vectors dₗ are the R_{yy}-conjugate direction vectors generated from the V-CG method, and the vectors uₗ and scalars λₗ are the eigenvectors and eigenvalues of the data covariance matrix R_{yy}, respectively. There are several points to be made about these formulas. First, the direction vectors dₗ and uₗ are computed without regard for minimization of the MSE. But once chosen, the step sizes are optimized to minimize the mean squared error that can be achieved with an estimator in the Hilbert space spanned by the random variables zₗ=dₗ^{T}y or vₗ=uₗ^{T}Y. Second, the rank-k CSM Wiener filter and the rank-k PC Wiener filter have the same MSE expression, the difference lies in their ways to choose the eigenvectors uₗ, (l=1, . . . k). From the MSE expressions, we note that the best choice for the conjugate direction vector dₗ in the CG-WF to maximize the quantity

$${Q}_{l} = \frac{{\vert {s}_{1}^{T} {d}_{l} \vert}^{2}}{{d}_{l}^{T} {R}_{yy} {d}_{l}}$$

would be the full-rank WF dₗ=R_{yy}⁻¹s₁. However, without resorting to matrix inversion, the CG-WF uses a few simpler steps to reach the full-rank WF solution. There exists a best choice of conjugate direction (CD) vectors dₗ's such that the MSE decreases the most at each stage, and a rank-k CG-WF simply uses one set of CD vectors initialized by the desired signal vector s₁ and the gradients. The computational advantage of the CG-WF (w/o eigen-analysis) over the CSM-WF (w/ eigen-analysis and sorting) is obvious. Using a block diagram, we present, in FIG. 9, the general structure of the reduced-rank V-CG Wiener filter, which consists of analysis and synthesis parts.

### IV. Convergence Analysis on the Reduced-Rank V-CG WF

In this section, we present convergence results, general and warp, for the reduced-rank V-CG WF for the CDMA application in equation (1).

### A. General Convergence Results

It has been shown in [10] that for a general quadratic problem the V-CG algorithm converges in N steps, where N is the dimension of the measurement y and the correlation matrix R_{yy}. However, when designing a MUD in a CDMA system, we show in this work that the V-CG converges in, at most, K steps (K≦N), where K is the number of active users in the system. This slightly improves on the result in [10], [2], in which convergence was guaranteed in at most (K+1) steps. This convergence is due to the fact that the R_{yy}-conjugate direction dₖ formed at each stage of the V-CG belongs to an expanding Krylov subspace, as does the corresponding reduced-rank Wiener filter vector wₖ. Specifically, we have

$${d}_{k} ∈ {𝒦}_{k} ( {R}_{yy} , {s}_{1} ) , and {w}_{k} = {\sum }_{i = 1}^{k} {α}_{i} {d}_{i} ∈ {𝒦}_{k} ( {R}_{yy} , {s}_{1} ) ,$$

where Kₖ(R_{yy}, s₁)=<s₁, R_{yy}s₁, . . . , R_{yy}^{k-1}s₁> is the Krylov subspace of dimension k [10]. Using the fact that,

$${R}_{yy} = {\sum }_{k = 1}^{K} {A}_{k}^{2} {s}_{k} {s}_{k}^{T} + {σ}^{2} I ,$$

we can further explicitly write the basis vectors of the expanding subspace Kₖ(R_{yy}, s₁) as

$$< {s}_{1} , {\sum }_{l = 1}^{K} {β}_{1 , l} {s}_{l} , … , {\sum }_{l = 1}^{K} {β}_{k - 1 , l} {s}_{l} > , \qquad ( 14 )$$

where the coefficients β_{k,l} depend on the signatures sₖ and the amplitudes Aₖ of all active users, and the noise power σ².

We notice that the expanding subspace is contained in the signal subspace <S> spanned by the signature vectors of all active users. Each basis vector in the Krylov subspace is therefore a linear combination of the K code vectors {s₁, s₂, . . . , s_{K}}, and there can be no more than K such linearly independent vectors. Therefore, in the general CDMA case, the subspace Kₖ(R_{yy}, s₁) stops expanding in dimension after at most the k=K iteration. This concludes our sketch proof of the (at most) K-stage (rank-K) convergence of the V-CG MUD.

### B. Warp Convergence Results

When implementing the MUD using the V-CG method, practical convergence occurs whenever the residue vector in equation (12) is smaller in norm than a preset threshold. Experimentally, we have observed that there exists an exact convergence in the V-CG method at warp speed, meaning that the subspace stops expanding at a stage well below K, for certain important applications in signal processing, adaptive beamforming, and wireless communications. In a CDMA system, under ideal near-far ratio (NFR) conditions among all users, using the same-length Gold codes, convergence can actually be reached either at the 2nd (for the use of a good set of Gold codes) or at the 4th (for the use of a bad set of Gold codes) iteration, independent of the number of users K and the spreading code length N. Even further, with a group-wise power scheme in combination with spreading code design, we can limit the convergence steps to certain prescribed values. This result is very useful in the down-link of CDMA systems, where power control can be achieved almost ideally for all active users (in groups). Here the distributed receiver for each desired user only needs to use its own signature code to achieve a performance equal to the full-rank LMMSE MUD in just L=2 to 4 iterations (L<<K≦N), independent of the total number of active users K and the spreading Gold code length N. The underlying reason for such a warp convergence occurring in the reduced-rank Wiener filter is due to the number of distinct eigenvalues of the data covariance matrix R_{yy} which induces a matrix annihilating equation of order-L (L<<N) [9]. We summarize, in a Theorem, the necessary and sufficient conditions for warp convergence in the V-CG reduced-rank Wiener filters.
Theorem (Warp Convergence in V-CG Reduced-Rank Wiener Filters):

$$Given {R}_{yy} = {\sum }_{k = 1}^{K} {A}_{k}^{2} {s}_{k} {s}_{k}^{T} + {σ}^{2} I ,$$

the reduced-rank conjugate gradient Wiener filter wₖ that lies in the Krylov subspace Kₖ(R_{yy}, s₁) yields the full-rank Wiener filter wₒₚₜ=R_{yy}⁻¹s₁ in at most k=L−1 steps, where L is the number of distinct eigenvalues of the matrix R_{yy}.
Proof: We use the concept of invariant subspace and orthogonal projections to prove the Theorem in a constructive way. A more general Theorem for applications with models other than (1) can be found in [9]. For a covariance matrix R_{yy} of L distinct groups of eigenvalues, using the spectral factorization theorem, for any integer 1≦k≦L, we have
R_{yy}^{k}=λ₁^{k}P₁+ . . . +λ_{L}^{k}P_{L}
where Pₗ=QₗQₗ^{T} is the orthogonal projection matrix on to the invariant subspace Qₗ=<Qₗ>. Columns of the rank-mₗ matrix Qₗ are the eigenvectors of R_{yy} associated with the eigenvalue λₗ (with a multiplicity mₗ).
For a CDMA system in (1), we have R_{yy}=SA²S^{T}+σ²I, then
λ₁=σ₁²+σ², . . . ,λ_{L-1}=σ_{L-1}²+σ²,λ_{L}=σ².
Furthermore, we have P_{L}S=0_{N×K}. Therefore, for every s₁ε<S>,

$${R}_{yy}^{k} {s}_{1} = {λ}_{1}^{k} {P}_{1} {s}_{1} + … + {λ}_{L - 1}^{k} {P}_{L - 1} {s}_{1} + \underbrace{{λ}_{L}^{k} {P}_{L} {s}_{1}}_{equals 0} ∈ {𝒬}_{1} ⊕ {𝒬}_{2} ⊕ … ⊕ {𝒬}_{L - 1} ,$$

holds for every integer k. Therefore, we have,

$${max}_{{s}_{1} ∈ < S >} \{ dim {𝒦}_{k} ( {R}_{yy} , {s}_{1} ) \} = min ( k , L - 1 ) .$$

Hence, the (L−1)-step convergence result for the V-CG method holds.

Note that our warp convergence theorem reveals important fundamentals behind the observation (based on the Cayley-Hamilton Theorem) that a small number of stages is needed in the polynomial expansion (PE) multiuser detector or the Cayley-Hamilton detector [11], [12]. However, we show that, contrary to common belief, it is the order, L, of the minimal polynomial, g(λ)=(λ−λ₁)(λ−λ₂) . . . (λ−λ_{L}), that determines convergence, and not the rank, K, of the signal covariance matrix

$${\sum }_{k = 1}^{K} {A}_{k}^{2} {s}_{k} {s}_{k}^{T} = {SA}^{2} {S}^{T} ,$$

or the code Grammian S^{T}S. This order is determined by the number of distinct eigenvalues of the signal covariance matrix

$${\sum }_{k = 1}^{K} {A}_{k}^{2} {s}_{k} {s}_{k}^{T} ,$$

which is related to the number of distinct eigenvalues of the signal Grammian G=AG_{SS}A where G_{SS}=S^{T}S is the code Grammian.

### V. Matrix Conjugate Gradient Wiener Filter

In a multiuser application of the V-CG algorithm, K V-CG algorithms, each using a different initial vector sₖ, must be run in parallel. Moreover, in these parallel filters there will be correlation between the internal variables uₗ^{(k)}=dₗ^{(k)T}y that is not exploited. Therefore, a bank of K uncoupled V-CG filters makes sub-optimum use of the data. The matrix conjugate gradient (M-CG) algorithm exploits these correlations to reach a faster convergence and, at the same time, decode all active users in one shot instead of using K parallel V-CG procedures for all K users.

The matrix Wiener filter applied to the problem of designing a MUD for the information vector of all K active users in a CDMA system is

$${W}_{WF} = arg {min}_{W} MSE ( \hat{b} )$$

where the objective function is

$$\begin{matrix}MSE ( \hat{b} ) {=}^{Δ} E \{ {‖ b - {W}^{T} y ‖}_{F}^{2} \} \\ = MMSE ( \hat{b} ) + tr \{ {( {R}_{yy} W - {R}_{yb} )}^{T} {R}_{yy}^{- 1} ( {R}_{yy} W - {R}_{yb} ) \} ,\end{matrix}$$

where ∥•∥_{F} stands for the Frobenius norm, and tr(•) is the trace operator. The minimum MSE,
MMSE(\hat{b})=tr{I−R_{yb}^{T}R_{yy}⁻¹R_{yb}},
is achieved when the matrix Wiener filter W_{WF}=R_{yy}⁻¹R_{yb} is used.

For CDMA applications, we have R_{yb}=SA so the matrix Wiener filter, the associated MUD for decoding the BPSK symbol vector b of all K users, and the MMSE are W_{WF}=R_{yy}⁻¹SA, \hat{b}=sgn{W_{WF}^{T}y}=sgn{S^{T}R_{yy}⁻¹y}, MMSE(\hat{b})=tr{I−AS^{T}R_{yy}⁻¹SA} Note again that the diagonal amplitude matrix A may be omitted from the W_{WF} without affecting the decision rule, the SINR, and the BER of the MUD. Our aim is to implement a normalized Wiener filter W_{NWF}=R_{yy}⁻¹S for MUD using a M-CG algorithm.

The M-CG algorithm for implementing the matrix Wiener filter and the MUD starts with the initial matrix filter W₀=0_{N×K}, the search direction matrix D₁=G₁, and the initial residual matrix G₁=S−R_{yy}W₀. The M-CG algorithm updates the filtering matrix as [13]
Wₖ=Wₖ₋₁+DₖVₖ,
where the step size matrix is calculated as follows:
Vₖ=(Dₖ^{T}R_{yy}Dₖ)⁻¹Gₖ^{T}Gₖ.
Similarly the residual matrix is updated according to
Gₖ₊₁=Gₖ−R_{yy}DₖVₖ; G₁=S.
The R-conjugate direction matrix is updated according to
Dₖ₊₁=Gₖ₊₁+Dₖ(Gₖ^{T}Gₖ)⁻¹Gₖ₊₁^{T}Gₖ₊₁; D₁=S.
As a matter of fact, when the initials are chosen as,
W₀=0_{N×K}, D₁=G₁=S.
then we notice the important fact that the updated residual matrix G₂ is simply a zero matrix:

$${G}_{2} = {G}_{1} - {R}_{yy} {D}_{1} {V}_{1} = S - {R}_{yy} {S ( {S}^{T} {R}_{yy} S )}^{- 1} {S}^{T} S = {0}_{N \times K}$$

The last equation can be seen from the orthogonality between subspaces <G₂> and <S>. That is,
S^{T}G₂=0_{K×K}<G₂>⊥<S>
G₂=ST_{R}=T_{L}S<G₂>⊂<S>
Combining these two results, we have G₂=0_{N×K}.

This result shows that the M-CG method converges to the full rank normalized Wiener filter W_{NWF}=R_{yy}⁻¹S=S(S^{T}S+σ²A⁻²)⁻¹A⁻² in just one step. That is, we can verify the fact that W₁=D₁V₁=W_{NWF}. This result is especially useful in the up-link of a CDMA system, where knowledge of all active users' signatures is available, and one-step convergence for the M-CG MUD guarantees MMSE performance for all users in one shot. Here, we should point out that in decoding information for all K active users, the V-CG based MUD needs operations on the order of O(kₛₜₑₚKN²); while the M-CG based MUD needs operations on the order of O(K³+K²N)=O(K²N).

### VI. Connection to the Orthogonal Multi-Stage Wiener Filter

It has be shown [2] that the orthogonal multi-stage Wiener filter (OMSWF) constructs the same normalized rank-k filter vector wₖ as the V-CG procedure, at each stage of iteration. In [14] this result is generalized to establish a one-to-one correspondence between the set of conjugate direction filters and (non-orthogonal) multi-stage Wiener filters [1], [15]. The only difference between the CGWF and the OMSWF is that the OMSWF successively uses a generalized sidelobe cancellation (GSC) idea to build a rank-k Wiener filter, wₖ, to approximate the full-rank Wiener filter in nested stages. In doing so, the rank-k Wiener filter is refined in the expanding Krylov subspace Kₖ(R_{yy}, s₁), spanned by a rank-k pre-processing matrix Tₖ^{(OMSWF)} with orthogonal columns. The matrix Tₖ^{(OMSWF)} (applied on data y) tr-diagonalizes the R_{yy} matrix. With much simplified computation, the V-CG method successively constructs the rank-k Wiener filter that is refined in the same expanding Krylov subspace spanned by R_{yy}-conjugate direction vectors Tₖ^{(VCGWF)}=[d₁ d₂ . . . dₖ]. The pre-processing matrix Tₖ^{(VCGWF)} (applied on data y) diagonalizes the R_{yy} matrix, hence bringing further simplification to the reduced-rank filter structure. Therefore, the warp convergence results obtained for the V-CG MUD designs also apply to the OMSWF MUD designs.

### VII. Simulation Results

Computer simulations and numerical evaluations based on analytical results in our previous paper [4] are given in this section. In all the experiments, we designed a CDMA system with K=10 active users, each using a distinct length N=15 Gold code. The SNR for the desired user (user 1) is fixed at SNR₁=A₁²/σ²=11 dB. To verify our results on the convergence of the CG WF MUD, different near-far ratios (NFRs) are used in the experiments.

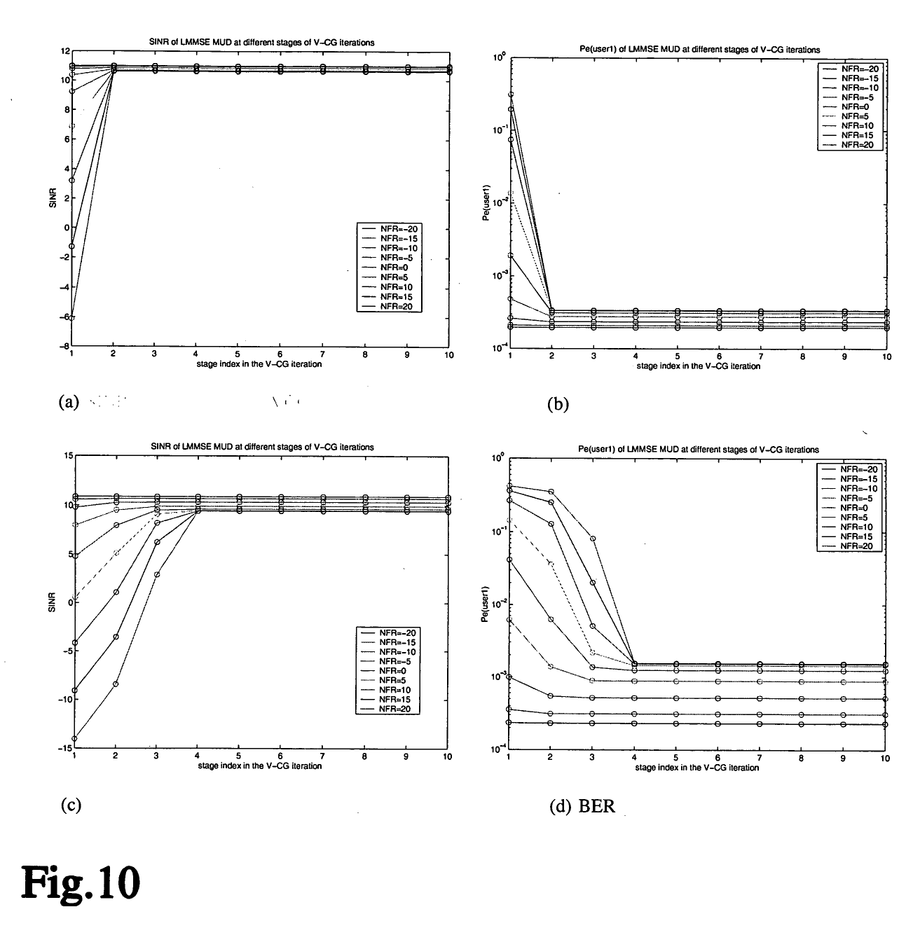

In FIG. 10 the SNRs for all interfering users are chosen as, SNRₖ=SNR₁+NFR in dB. FIG. 10 (a-b) show results for the case when a good set of Gold codes is chosen, so that sₖ^{T}s₁=−1/N, (k=2, 3, . . . , K). In this case, the K×K code Grammian

$${G}_{SS} = \frac{N + 1}{N} {I}_{K \times K} - \frac{1}{N} {11}^{T}$$

as well as the signal Grammian G contains only two distinct eigenvalues. Using this and the subspace expansion in (15) we can argue that in this case the V-CG WF MUD converges to the optimal full-rank MUD in just 2 steps. FIG. 10 (c-d) shows results for the case when a bad set of Gold codes is chosen, so that sₖ^{T}s₁, (k=2, 3, . . . , K) has three different values. In this case, the K×K code Grammian G_{SS} as well as the signal Grammian G contains four distinct eigenvalues. Again with the subspace expanding argument, the V-CG WF MUD converges to the optimal full-rank MUD in just 4 steps.

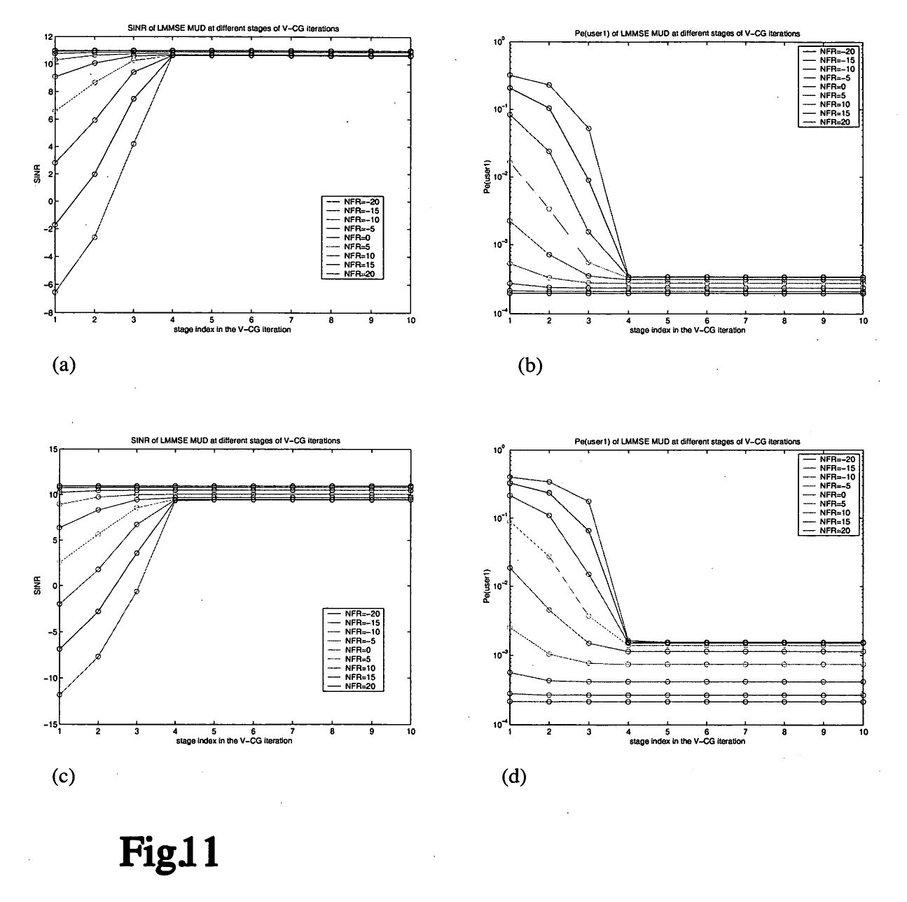

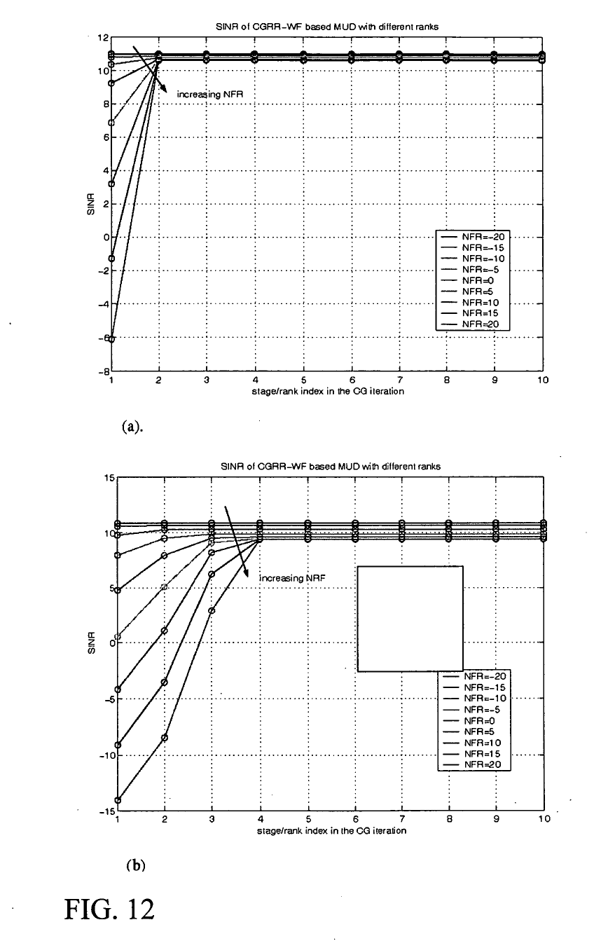

In FIG. 11, all 9 interfering users are grouped into three sub-groups: one sub-group with SNRₘ=SNR₁+NFR in dB, another sub-group with SNRₕ=SNRₘ+3 dB, and yet another sub-group with SNRₗ=SNRₘ−3 dB. FIG. 11 (a-b) show results for the case when a good set of Gold codes is chosen along with a group-wise power control. In this case, the K×K signal Grammian G=AG_{SS}A contains four distinct eigenvalues. As predicted by the subspace expansion argument in (15), in this case the V-CG WF MUD converges to the optimal full-rank MUD in just 4 steps. FIG. 11 (c-d) shows results for the case when a bad set of Gold codes is chosen along with a group-wise power control. In this case, we use a strategy of properly grouping interfering users according to the three values of cross-correlations, so that the K×K signal Grammian G=AG_{SS}A still contains four distinct eigenvalues. Again, as predicted by the subspace expansion argument in (15), in this case the V-CG WF MUD converges to the optimal full-rank MUD in just 4 steps.

### VIII. Conclusions

We have introduced the matrix conjugate gradient (M-CG) method into the design of reduced-rank Wiener filter for multiuser detection in CDMA systems, and proved warp convergence for the vector conjugate gradient (V-CG) method. Using a subspace framework, we have shown that the V-CG WF MUD converges in at most K steps while the M-CG WF MUD converges in just one step. With power control among all users using Gold codes as their spreading codes, we have proved warp convergence for the reduced-rank V-CG WF MUD in 2 to 4 steps, independent of the number of users and spreading factor. Furthermore, we can properly design a groupwise power allocation scheme among all users using Gold codes, so that the rank-4 V-CG WF MUD will guarantee to deliver the performance of the optimal full-rank WF MUD. Replacing the data correlation matrix by the code correlation matrix, results obtained here for the CG WF MUD also apply to the design of decorrelating MUDs.

### REFERENCES

[1] J. S. Goldstein, I. S. Reed, and L. L. Scharf, “A Multistage Representation of the Wiener Filter Based on Orthogonal Projections,” IEEE Trans. on Information Theory, vol. 44, pp. 2943-2959, November 1998.
[2] M. E. Weippert, J. D. Hiemstra, J. S. Goldstein, and M. D. Zoltowski, “Insights from the Relationship between the Multistage Wiener Filter and the Method of Conjugate Gradients,” Proceedings of the second IEEE Workshop on Sensor Array and Multichannel Signal Processing, Washington, D.C., August 2002.
[3] M. R. Hestenes, and E. Stiefel, “Methods of Conjugate Gradients for Solving Linear Systems,” J. Res. Nat. Bur. Stand., vol. 49, pp. 409-436, 1952.
[4] H. Ge, “The LMMSE Estimate based Multiuser Detectors: Performance Analysis and Adaptive Implementation,” Proceedings of the IEEE Int'l Conf. on Acoustics, Speech, and Signal Processing, pp. 571-574, 1997.
[5] H. V. Poor, and S. Verdú, “Probability of Error in Multiuser Detection,” IEEE Trans. on Inform. Theory, vol. 43, pp. 858-871, May 1997.
[6] D. W. Tufts, R. Kumaresan, and I. Kirsteins, “Data Adaptive Signal Estimation by Singular Value Decomposition of a Data Matrix,” Proceedings of the IEEE, vol. 7, pp. 684-685, 1982.
[7] J. S. Goldstein, and I. S. Reed, “Subspace Selection for Partially Adaptive Sensor Array Processing,” IEEE Trans. on Aerospace and Electronics Systems, vol. 33, no. 2, pp. 529-544, April 1997.
[8] X. Cai, H. Ge, and A. N. Akansu, “Blind Reduced-Rank MMSE Detector for DS-CDMA Systems,” EURASIP Journal on Applied Signal Processing, 2002:12, pp. 1365-1376, December 2002.
[9] H. Ge, M. Lundberg, and L. L. Scharf, “Warp Convergence in Reduced-Rank Conjugate Gradient Wiener Filters,” Proc. of the third IEEE Workshop on Sensor Array and Multichannel Signal Processing, July 2004.
[10] G. H. Golub, and C. F. Van Loan, Matrix Computations, The Johns Hopkins University Press, Baltimore and London, second edition, 1993.
[11] S. Moshavi, “Multiuser Detection for DS-CDMA Communications,” IEEE Communications Magazine, pp. 124-136, October 1996.
[12] S. Moshavi, E. G. Kanterakis, and D. L. Schilling, “Multistage linear receivers for DS-CDMA systems,” International Journal of Wireless Information Networks, no. 1, vol. 3, pp. 1-17, July 1996.
[13] D. P. O'Leary, “The Block Conjugate Gradient Algorithm and Related Methods,” Linear Algebra and its Applications, vol. 29, pp. 293-322, 1980
[14] L. L. Scharf, L. T. McWhorter, E. K. P. Chong, J. S. Goldstein, and M. D. Zoltowski, “Algebraic Equivalence of Conjug; Direction and Multistage Wiener Filters,” the 11th Annual MIT Lincoln Labs Workshop on Adaptive Sensor Array Processing, Lexington, Mass. Mar. 2003.
[15] M. L. Honig, and W. Xiao, “Performance of Reduced-Rank Linear Interference Suppression,” IEEE Trans. on Information Theory, vol. 47, pp. 1928-1946, July 2001.
   Part B—Warp Convergence in Conjugate Gradient Wiener Filters

### I. Introduction

Many advanced signal processing systems, ranging from linear filters for space-time adaptive processing in radar and sonar systems, to signal separation and interference suppression in communications, involve such filtering operations as s^{H}R_{yy}⁻¹s, and s^{H}R_{yy}⁻¹y, where R_{yy} is the covariance matrix of the measurement vector y, and the vector s denotes the signal mode of interest. The signal mode s can either be parameterized by the temporal/spatial frequencies in space-time adaptive processing, or as the signature vectors in a spread spectrum CDMA system. In practice, the dimension, N, of the vectors s, y and the matrix R_{yy} may be very large. This not only causes slow convergence during the real-time adaptation of the systems in dynamically changing interference environments, but also causes performance degradation of the system when only a small number of data samples are available for estimating the data statistics.

In this work, we study the conjugate gradient (CG) method [1] from the perspective of expanding subspaces, for iteratively designing reduced-rank (RR) Wiener filters (WF) [2], [3], [4] in array processing, robust beamforming and communications. At each iteration stage of the CG algorithm, a RR WF, contained in an expanding Krylov subspace, Kₗ(R_{yy}, s) [3], [5], is constructed. We study in-depth the cases when the Gram matrix of the signal modes has a structure that leads to warp convergence of the RRCG WF [6]. This finding will be useful during the adaptive implementation of systems for communication and array processing. Computer simulations verify the remarkably fast convergence of the RRCG Wiener filters predicted by our theoretical results. This warp convergence is much faster than predicted by standard results in [3], [5].

### II. Notion of Expanding Subspaces

Let us assume that the measurement vector y follows a linear model,
y=Sθ+n, (15)
where the matrix S=[s₁ s₂ . . . s_{K}] contains signal modes for all sources; the random vector θ=[θ₁ θ₂ . . . θ_{K}]^{T} contains information carried by signal modes; the noise vector, n˜CN(0, σ²I), is proper complex white Gaussian. In this work, we choose the mode s₁ as the desired signal mode for CDMA communications and beamforming on a single source. The rest of the modes, sₖ_{₁}(k=2, 3, . . . , K), are treated as interferences. For multi-source robust beamforming, we choose the desired signal mode from a subset of the signal mode matrix S.

The full-rank data covariance matrix R_{yy} often has the structure,

$${R}_{yy} = {SPS}^{H} + {σ}^{2} I = {\sum }_{k = 1}^{K} {P}_{k} {s}_{k} {s}_{k}^{H} + {σ}^{2} I , \qquad ( 16 )$$

where the diagonal matrix P=diag{P₁, P₂, . . . , P_{K}}, with Pₖ=E{|θₖ|²}, contains the power for each of K uncorrelated sources. The Gram matrix of the signal mode matrix is G_{SS}=S^{H}S. Previous convergence results [3], [5] have been based on the rank K of the structured part of R_{yy}. Our results are based on a more refined analysis of the eigen-structure of R_{yy}.

We have been motivated in our study by the application of the RRCG WF to problems where the Grammian S^{H}S has a small number of distinct eigenvalues, compared with its rank. Rather amazingly, this situation arises in many branches of engineering and statistics.

The equivalence between the vector conjugate gradient (V-CG) method and the orthogonal multi-stage (OMS) approach for Wiener filter design was reported in [3] and generalized in [4]. To approximate the full-rank Wiener filter, at the k-th stage of iteration, both approaches construct a rank-k Wiener filter, wₖ, that lies in the expanding Krylov subspace Kₖ(R_{yy}, s₁). The OMS approach [3] uses the orthogonal gradient vectors to construct the RR WF, which relies on the nested scalar synthesis filters. With much simplified computation, the V-CG method uses the R_{yy}-conjugate direction vectors dₖ to construct the RR WF. Specifically, using the V-CG method with initial w₀=0 and d₀=s₁, a rank-k Wiener filter is [6]

$${w}_{k} = {\sum }_{l = 0}^{k - 1} {γ}_{l} {d}_{l} , \\ with$$

$${γ}_{l} = \frac{{s}_{1}^{H} {d}_{l}}{{d}_{l}^{H} {R}_{yy} {d}_{l}} ,$$

where the conjugate direction vectors satisfy dₗ^{H}R_{yy}dₘ=0, for l≠m. The coefficients γₗ are simply the scalar Wiener filters working on the decorrelated internal variables, dₗ^{H}y.

In this work, we prove that the RRCG Wiener filter,
wₗ^{(RRCG)}=SₗμₗεRange(Sₗ),
Sₗ=[s₁,R_{yy}s₁, . . . ,R_{yy}^{l-1}s₁],
converges to the full-rank Wiener filter, w_{WF}=R_{yy}⁻¹s₁, in at most L steps, where the number of distinct eigenvalues of R_{yy} is L. It converges in at most (L−1) steps when R_{yy} has the structured form of (2) and the vector s₁ is an element of <S>. This means a rank-L RRCG WF delivers the same performance as that of the full-rank WF. This is due to the fact that at each iteration of the V-CG method, a RR-WF is constructed from the expanding Krylov subspace Kₗ(R_{yy}, s₁)=<Sₗ>, and the subspace does not expand past l=L. In other words, for applications where L<<K, we can reduce the rank down to L during the construction of the RR-WF using the V-CG method, yet still deliver the same performance as the full-rank WF.

Note that earlier results on the (K+1)-step [3], [5] or the K-step [6] convergence for R_{yy} of the form (2) still apply to problems without repeated eigenvalues.

### III. The Warp Convergence Theorem in RRCG Wiener Filters

We summarize our results for the warp convergence of the reduced-rank vector conjugate gradient (V-CG) Wiener filter using a Theorem and a Corollary.
Theorem: For 1≦l≦N and 1≦L≦N, the maximum dimension of the Krylov subspace Kₗ(R_{yy}, s), over all sεC^{N}, equals the min(l, L), if and only if the number of distinct eigenvalues of R_{yy} denoted # dev(R_{yy}), is L. That is,

$${max}_{s ∈ {C}^{N}} \{ dim {𝒦}_{l} ( {R}_{yy} , s ) \} = min ( l , L ) ⇔ \# dev ( {R}_{yy} ) = L .$$

Remarks: This is an if and only if statement that may be interpreted to read “The Krylov subspace stops expanding in a number of steps that cannot exceed the number of distinct groups of eigenvalues of R_{yy}”. For many applications, for which R_{yy}=Rₛₛ+σ²I, this number L is much smaller than rank(Rₛₛ)+1, which is the maximum dimension of Kₗ(R_{yy}, s) for covariance matrices Rₛₛ that have distinct eigenvalues. So, contrary to common belief, it is the minimal polynomial of R_{yy} that determines convergence, and not the characteristic polynomial, as our proof will show.
Proof: The proof consists of two parts.
(The sufficient condition or the “if part”)
Assume that # dev(R_{yy})=L. Then the characteristic polynomial of R_{yy} is
Δ_{R}_{_{yy}}(λ)=(λ−λ₁)^{m}^{₁}(λ−λ₂)^{m}^{₂} . . . (λ−λ_{L})^{m}^{_{L}},
with m₁+m₂+ . . . +m_{L}=N. The polynomial Δ_{R}_{^{yy}}(λ) is divisible without remainder by the minimal polynomial

$$g ( λ ) = ( λ - {λ}_{1} ) ( λ - {λ}_{2} ) ⋯ ( λ - {λ}_{L} ) = {\sum }_{l = 0}^{L} {α}_{l} {λ}^{l} ,$$

and g(R_{yy})=0_{N×N}. Hence, the vectors R_{yy}^{l}s cannot expand the dimension of the Krylov subspace Kₗ(R_{yy}, s) for any l≧L.
(The necessary condition or the “only if part”)
Let L be the integer for which

$${max}_{s ∈ {C}^{N}} \{ dim {𝒦}_{l} ( {R}_{yy} , s ) \} = min ( l , L )$$

holds. Then, L is the smallest integer such that

$$g ( {R}_{yy} ) = {\sum }_{l = 0}^{L} {α}_{l} {R}_{yy}^{l} = {0}_{N \times N} ,$$

for some α₀, α₁, . . . α_{L-1}, and α_{L}=1.
This makes

$$g ( λ ) = {\sum }_{l = 0}^{L} {α}_{l} {λ}^{l}$$

the minimal polynomial of R_{yy}. This minimal polynomial divides the characteristic polynomial, Δ_{R}_{_{yy}}(λ), of R_{yy}. That is,
Δ_{R}_{_{yy}}(λ)=(λ−λ₁)^{m}^{₁}(λ−λ₂)^{m}^{₂} . . . (λ−λ_{L})^{m}^{_{L}},
and
g(λ)=(λ−λ₁)^{μ}^{₁}(λ−λ₂)^{μ}^{₂} . . . (λ−λ_{L})^{μ}^{_{L}},
with 1≦μₗ≦mₗ. The parameter μₗ, which is the size of the largest Jordan block corresponding to λₗ, is 1 for any diagonalizable matrix. Thus the minimal polynomial g(λ) has order μ=L, which is the number of distinct eigenvalues of R_{yy}. Q.E.D.

Note that for many applications, we have R_{yy}=Rₛₛ+σ²I, with Rₛₛ=SS^{H}, and the initial vector s used to construct the Krylov subspace Kₗ(R_{yy}, s) belongs to the signal subspace <S>. For such a choice of sε<S>, we also develop a Corollary of the warp convergence Theorem.
Corollary: Assume R_{yy}=SS^{H}+σ²I. For 1≦l≦N and 1≦L≦N, the maximum dimension of the Krylov subspace Kₗ(R_{yy}, s), over all sε<S>, equals the min(l, L−1), if and only if the number of distinct eigenvalues of R_{yy}, # dev(R_{yy}), is L. That is,

$${max}_{s ∈ < S >} \{ dim {𝒦}_{l} ( {R}_{yy} , s ) \} = min ( l , L - 1 ) ⇔ \# dev ( {R}_{yy} ) = L .$$

Remarks: This Corollary says that if the initial vector sε<S> instead of sεC^{N}, the warp convergence rank (L−1) is determined by the number of distinct eigenvalues of the K×K Gramirian G_{SS}=S^{H}S. The N×N signal covariance matrix Rₛₛ=SS^{H}, which is of rank K, has the same number, L, of distinct eigenvalues as the R_{yy}. This number, L, is one more than the number of distinct eigenvalues of the Grammian G_{SS}.
Proof: We use the concept of invariant subspace and orthogonal projections to prove the Corollary in a constructive way. For a covariance matrix R_{yy} of L distinct groups of eigenvalues, using the spectral factorization theorem, for any integer 1≦l≦L, we have
R_{yy}^{l}=λ₁^{l}P₁+ . . . +λ_{L}^{l}P_{L}
where Pₗ=QₗQₗ^{H} is the orthogonal projection matrix on to the invariant subspace Qₗ=<Qₗ>. Columns of the rank-mₗ matrix Q, are the eigenvectors of R_{yy} associated with the eigenvalue λₗ (with a multiplicity mₗ).
For R_{yy}=SS^{H}+σ²I, then
λ₁=σ₁²+σ², . . . ,λ_{L-1}=σ_{L-1}²+σ²,λ_{L}=σ².
Furthermore, we have P_{L}S=0_{N×K}. Therefore, for every sε<S>,

$${R}_{yy}^{l} s = {λ}_{1}^{l} {P}_{1} s + ⋯ + {λ}_{L - 1}^{l} {P}_{L - 1} s + \underbrace{{λ}_{L}^{l} {P}_{L} s}_{equals 0} \\ ∈ {𝒬}_{1} ⊕ {𝒬}_{2} ⊕ ⋯ ⊕ {𝒬}_{L - 1} ,$$

which has dimension dim≦L−1.
Therefore, we have,

$${max}_{s ∈ < S >} \{ dim {𝒦}_{l} ( {R}_{yy} , s ) \} = min ( l , L - 1 ) .$$

Q.E.D.

### IV. Applications

We present a few applications from communications and array processing to demonstrate the warp convergence of the RRCG Wiener filter.

A. Application in CDMA Systems

For synchronous CDMA applications, the data model in (1) is real-valued, and columns of the S matrix stand for signature vectors (normalized spreading codes) of all active users in the system. When a set of K length-N Gold codes is chosen as spreading codes, we can always decompose the Gram matrix in the form of,

$${G}_{SS} = {α}_{0} {I}_{K \times K} + {\sum }_{l = 1}^{L - 1} {α}_{l} {u}_{l} {u}_{l}^{H} = {α}_{0} {I}_{K \times K} + {\sum }_{l = 1}^{L - 1} {β}_{l} {q}_{l} {q}_{l}^{H} ,$$

where the (K×1) vectors uₗ are linearly independent of each other; and the vectors qₗ are orthogonal. Specifically, when a good set of Gold codes is chosen, we have [6]

$${G}_{SS} = {G}_{0} = \frac{N + 1}{N} {I}_{K \times K} - \frac{1}{N} {11}^{T} ,$$

where 1 stands for a (K×1) vector of all ones, and when a bad set of Gold codes is chosen, we have [6]

$${G}_{SS} = {G}_{0} + \frac{t}{N} ( {uv}^{T} + {vu}^{T} ) = {G}_{0} + \frac{t}{2 N} ( {q}_{2} {q}_{2}^{T} - {q}_{3} {q}_{3}^{T} ) .$$

The constant t is related to the three-value cross-correlation property of Gold codes. The vectors u and v contain only elements drawn from {−1, 0, +1}. The vectors q₂ and q₃ are q₂=u+v and q₃=u−v. The presence of terms uv^{T} and vu^{T} is due to the inclusion of Gold codes with bad cross-correlation in the code signature matrix S. The effect of these terms is to sparsely place elements with opposite values t/N and −t/N on the locations above and below the main diagonal of the G_{SS}. Most importantly, these additional dyad terms in the Gram matrix G_{SS} reveal the factors that cause the non-orthogonality among signal modes. They dictate additional steps needed, in additional to the first stage matched filtering w₁^{(RRCG)=s}₁, for the V-CG method to converge to the full-rank Wiener solution R_{yy}⁻¹s₁. This observation implies that under ideal power control, the RRCG WF multiuser detector (MUD) should converge to its full-rank counterpart within only 2 to 4 iterations [6]. Furthermore, we can also design a groupwise power control scheme for users (using Gold codes) with four different transmission power levels, so that the 4-stage convergence property of the RRCG-WF still holds. Simulation results in FIG. 1 demonstrate the fast convergence results of the RRCG WF used in implementing a MUD in CDMA systems with K=10 active users, each using a distinct Gold code of length N=15. We fixed the SNR₁ [symbol] P₁/σ²=11 dB for the desired user, and SNRₖ [symbol] Pₖ/σ²=SNR₁+NFR, (k=2, 3, . . . , K) for all interfering users. The near-far-ratio (NFR) is defined as the ratio between Pₖ and P₁ in dB.
B. Application in Adaptive Array Signal Processing

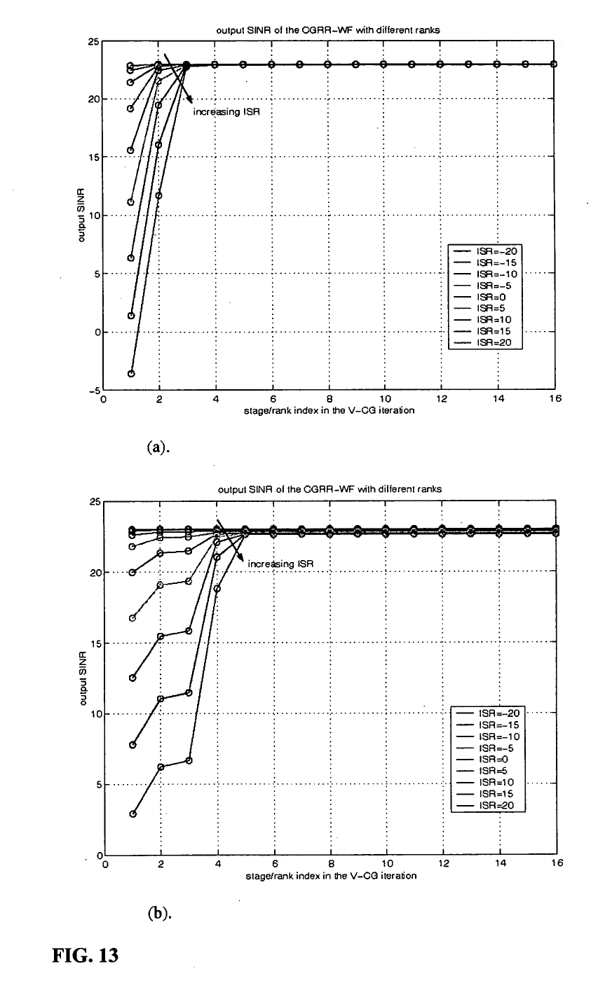

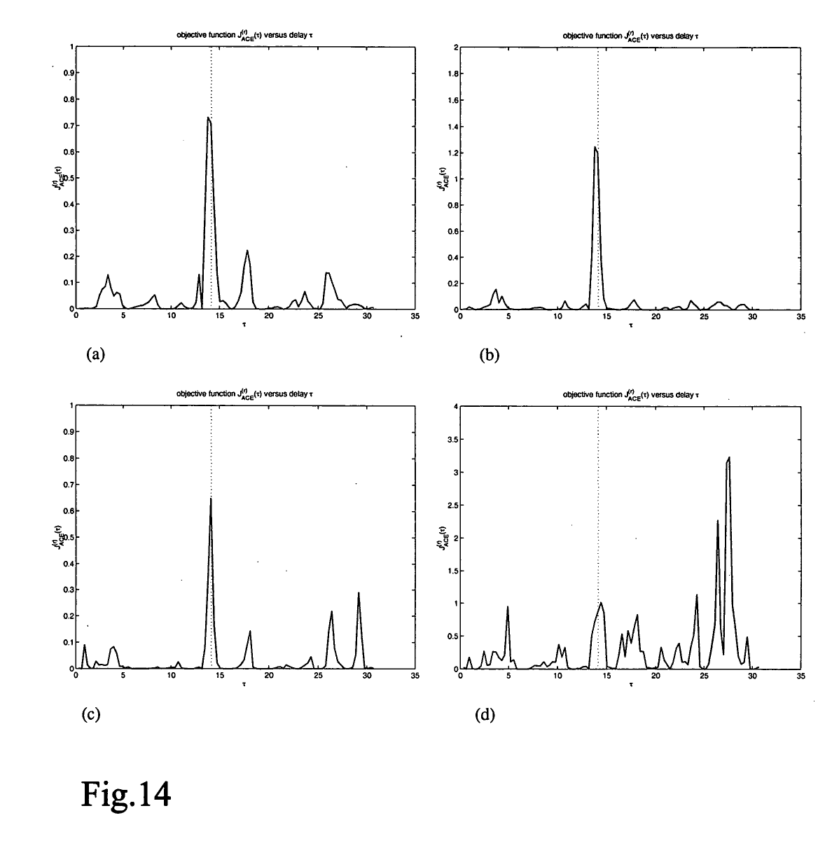

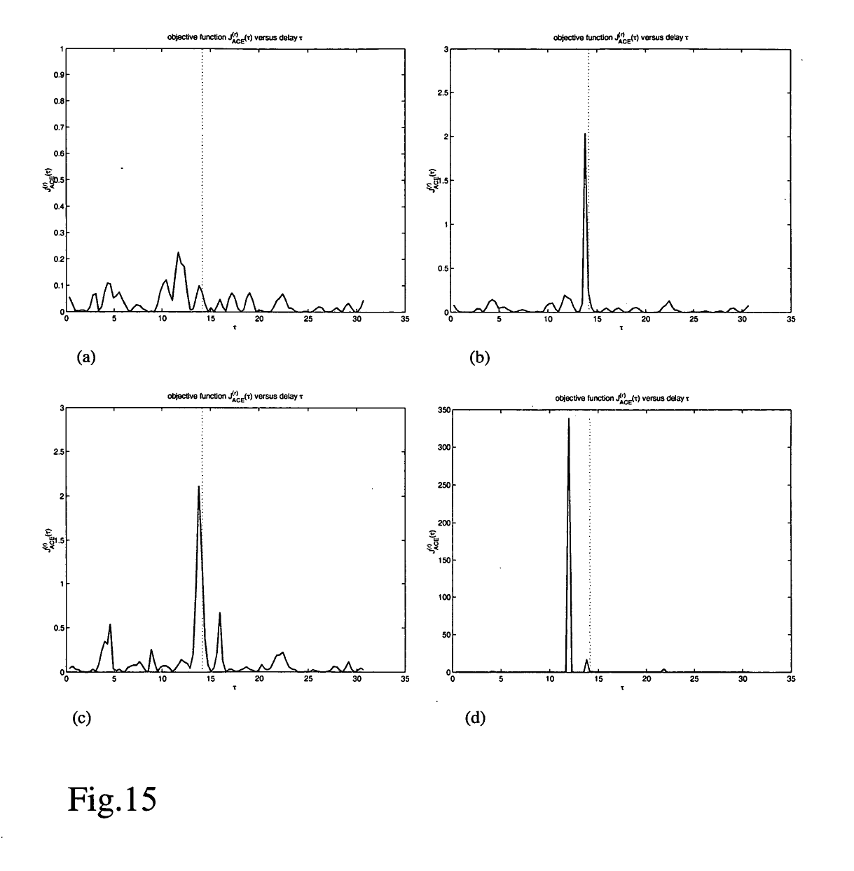

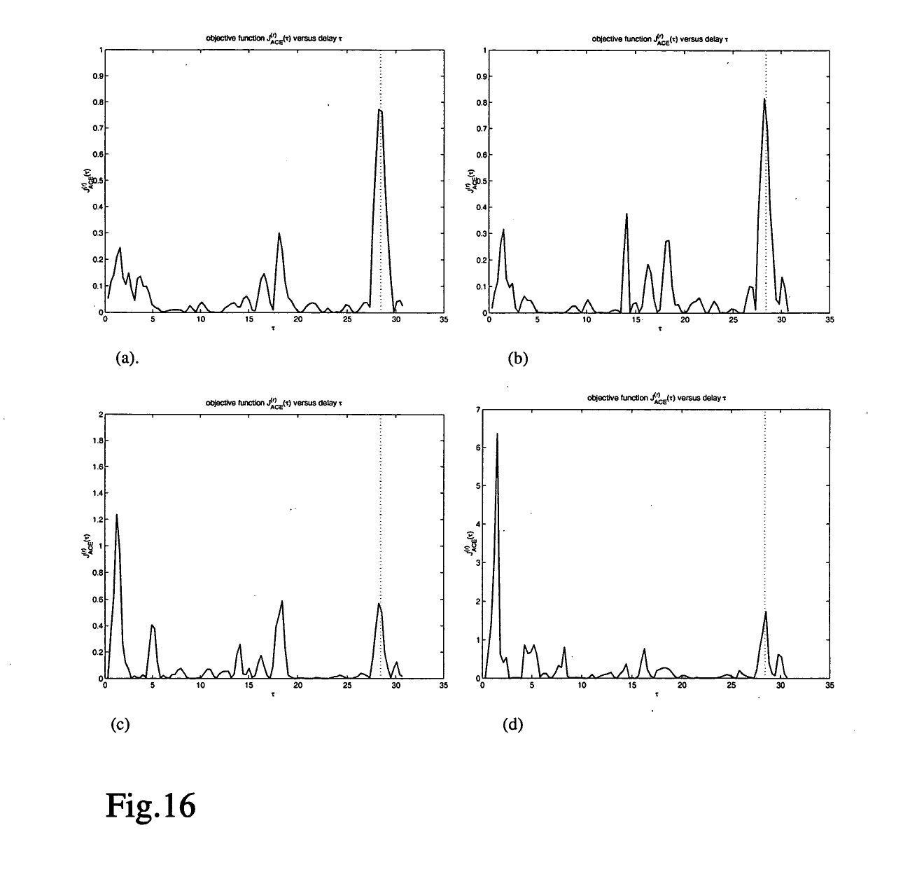

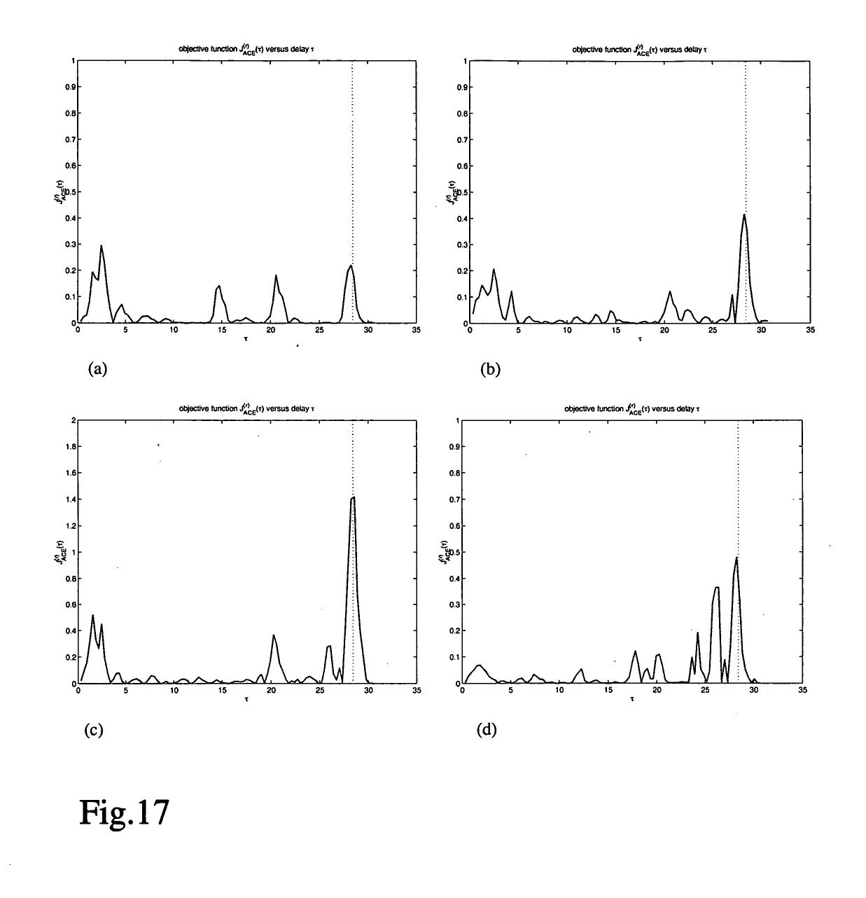

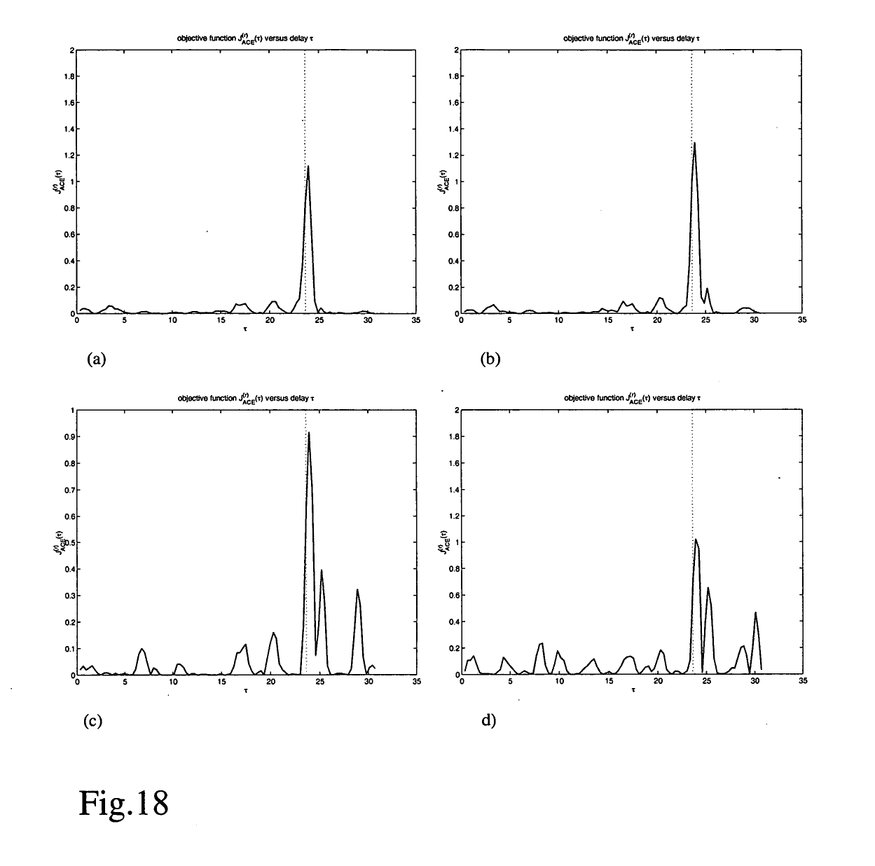

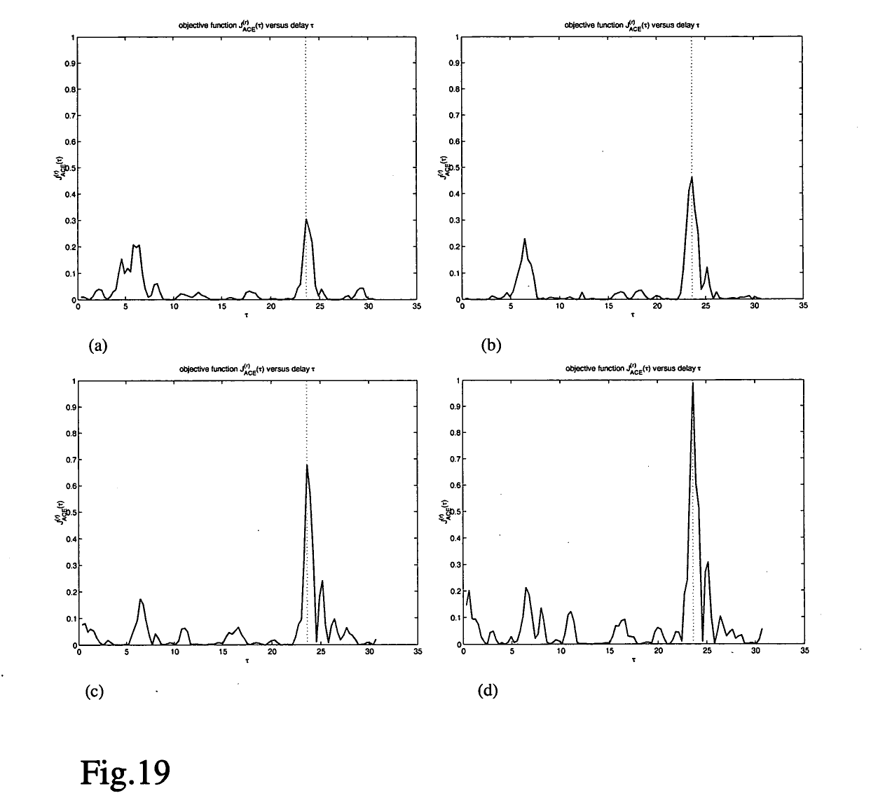

In array processing applications, the complex-valued snapshot from a given N-element uniform linear array (ULA), in response to K signal modes, follows the model in (1). Here the signal modes (columns of the S matrix) are parameterized by the angles of arrival of different sources,
S=[s(v₁)s(v₂) . . . s(v_{K})].
When all the modes are orthogonal, we have s^{H}(vₖ)s(vₗ)=Nδ_{k,l} and G_{SS}=NI_{K×K}. However, when the signal of interest, s₁=s(v₁), and interfering sources, s(vₖ)'s, (k=2, 3, . . . K), are not orthogonal, the RRCG WF can be used to filter out the desired signal mode. In such cases, we have

$${G}_{SS} = {NI}_{K \times K} + {\sum }_{l = 1}^{2 {L}_{0}} {α}_{l} {q}_{l} {q}_{l}^{H} ,$$

where the 2 L₀ unitary dyads account for L₀ modes that force G_{SS} away from the NI_{K×K}. For many applications, we experience fast and early convergence in at most L steps with L=2L₀+1<<K. In FIG. 13, we simulate a case where there are K=10 spatially distributed far-field sources impinging on a N=16 elements ULA. The source of interest, s(v₁) with a SNR₁=P₁/σ²=11 dB is not orthogonal to all interfering sources, s(v₂) . . . s(v_{K}). Among K=10 modes, we randomly perturb two modes so that they are not orthogonal to mode s₁. Using the RRCG WF, we expect convergence in at most L=5 steps. FIG. 13 verifies the early convergence of the RRCG WF predicted by our theoretical results. Different levels of interference to signal ratio (ISR), SIR=Pₖ/P₁, (k=2, 3, . . . , K) in dB, are chosen.

Similar predictable convergence behavior can be observed for other experimental setups, where the spacing between array elements (due to the break-downs of some sensors in the array structure or the environmental constraints on sensor distribution), along with the arbitrary DOAs of sources, make the Gram matrix of signal modes deviate from the diagonal matrix. These results might clarify other findings for RRCG WF applied to multi-sensor arrays [7].

### V. Conclusions

Conventional convergence analysis of the V-CG algorithm, whether for optimization or signal processing, has been based on the rank of a signal covariance matrix, or equivalently on the order of its characteristic polynomial. In this paper we show that it is the order of the minimal polynomial that determines convergence. This order is determined by the number of distinct eigenvalues of the signal covariance matrix, or its Grammian. For many problems in statistics, communication, and array processing, this number is much smaller than the rank of the Grammian, leading to warp convergence.

### REFERENCES

[1] M. R. Hestenes and E. Stiefel, “Methods of conjugate gradients for solving linear systems,” J. Res. Nat. Bur. Stand., vol. 49, pp. 409-436, 1952.
[2] J. S. Goldstein, I. S. Reed, and L. L. Scharf, “A multistage representation of the wiener filter based on orthogonal projections,” IEEE Trans. on Information Theory, vol. 44, pp. 2943-2959, November 1998.
[3] M. E. Weippert, J. D. Hiemstra, J. S. Goldstein, and M. D. Zoltowski, “Insights from the relationship between the multistage wiener filter and the method of conjugate gradients,” Proceedings of the second IEEE Workshop on Sensor Array and Multichannel Signal Processing, August 2002.
[4] L. L. Scharf, L. T. McWhorter, E. K. P. Chong, J. S. Goldstein, and M. D. Zoltowski, “The exact algebraic equivalence of conjugate direction and multistage wiener filters,” 11th Annual MIT Lincoln Labs Workshop on Adaptive Sensor Array Processing, Lexington, Mass., March 2003.
[5] G. H. Golub and C. F. Van Loan, “Matrix computations,” The Johns Hopkins University Press, Baltimore and London, second edition, 1993.
[6] H. Ge, L. L. Scharf, and M. Lundberg, “Reduced-rank multiuser detectors based on vector and matrix conjugate gradient Wiener filters,” Proc. of the fifth IEEE Workshop on Signal Processing Advances in Wireless Communications, July 2004.
[7] M. Zoltowski and E. Santos, “Matrix conjugate gradients for the generation of high resolution spectragrams,” Proc. of the 37th IEEE Asilomar Conf on Signals, Systems, and Computers, pp. 1843-1847, November 2003.
   Part C—Rank Reduction for Rapid Timing Acquisition in Multiple Access Communications

### I. Introduction

Synchronization or timing acquisition is an important aspect of every communication system. From a signal processing perspective, timing acquisition is related to the traditional time delay estimation problem in the presence of multiple access interference and ambient noise. The time delay parameters are typically non-linearly entered in the data model, resulting in a non-linear parameter estimation problem. The maximum likelihood estimation of the non-linear parameters boils down to a peak search of an objective function, commonly named the compressed likelihood function (CLF), over the parameter space. For our problem, the CLF, is the ratio of quadratic forms involving data covariance matrix inversion. When only a finite amount of data rather than the true covariance matrix is available for timing acquisition, a reliable low-complexity data-driven solution is in need. In this work, we develop a reduced-rank data-driven solution that avoids the matrix inversion and only uses very few data snapshots, for rapid timing acquisition in a multiple access communications system.

### II. Problem Formulation

In an asynchronous multiple access system over the additive Gaussian noise channel, the baseband data r(t) can be modeled as,

$$r ( t ) = {\sum }_{i} {\sum }_{k = 1}^{K} {A}_{k} {b}_{k} ( i ) {s}_{k} ( t - {τ}_{k} - iT ) + n ( t ) , \qquad ( 17 )$$

where K is the number of active MA users; i is the symbol index; Aₖ, bₖ(i), τₖ, and sₖ(t) are the amplitude, BPSK information bit, propagation delay, and signature waveform (normalized within symbol interval T) of the kth user, respectively; n(t) is a white Gaussian process with an average power of σ². The signature waveform is generated based on a binary signature sequence sₖ[l]ε{−1, +1} and the rectangular pulse of chip duration. That is,

$${s}_{k} ( t ) = \frac{1}{{LT}_{c}} {\sum }_{l = 1}^{L} {s}_{k} [ l ] p ( t - {lT}_{c} ) , \qquad 0 \leq t \leq T .$$

with T=LT_{c}. Denote the k-th user's propagation delay as τₖ=vₖT_{c}+γₖ, where vₖ and γₖ are the integer and the fractional parts of τₖ with respect to the chip duration T_{c}. In our further analysis and simulations, we choose a normalized chip interval, T_{c}=1. Within the i-th processing interval of length T, which is commonly not aligned with the unknown delay, the chip-rate matched filtered and sampled data in (17) can be written in matrix form as,

$$r ( i ) = \underbrace{{A}_{1} ( {b}_{1} ( i - 1 ) {u}_{1}^{( r )} + {b}_{1} ( i ) {u}_{1}^{( l )} )}_{signal of interest} + \underbrace{{\sum }_{k = 2}^{K} {A}_{k} ( {b}_{k} ( i - 1 ) {u}_{k}^{( r )} + {b}_{k} ( i ) {u}_{k}^{( l )} )}_{MAI} + n ( i ) , \qquad ( 18 )$$

where the i.i.d. white noise vectors n(i)˜N(0, σ²I_{L}). The (L×1) vectors uₖ^{(r)} and uₖ^{(l)} are the effective signature vectors of the kth user, parameterized by the delay τₖ, i.e.,

$${u}_{k}^{( r )} = ( 1 - \frac{{γ}_{k}}{{T}_{c}} ) {s}_{k}^{( r )} ( {v}_{k} ) + \frac{{γ}_{k}}{{T}_{c}} {s}_{k}^{( r )} ( {v}_{k} + 1 ) , \\ {u}_{k}^{( l )} = ( 1 - \frac{{γ}_{k}}{{T}_{c}} ) {s}_{k}^{( l )} ( {v}_{k} ) + \frac{{γ}_{k}}{{T}_{c}} {s}_{k}^{( l )} ( {v}_{k} + 1 ) , \qquad ( 19 )$$

with sₖ^{(r)}(vₖ) and sₖ^{(l)}(vₖ) being the right and left portions of signature vector sₖ partitioned by the integer part of delay vₖ. That is,

$${s}_{k}^{( l )} ( {v}_{k} ) = [ \begin{matrix}0 \\ ⋮ \\ 0 \\ {s}_{k} [ 1 ] \\ {s}_{k} [ 2 ] \\ ⋮ \\ {s}_{k} [ L - {v}_{k} ]\end{matrix} ] , {s}_{k}^{( r )} ( {v}_{k} ) = [ \begin{matrix}{s}_{k} [ L - {v}_{k} + 1 ] \\ {s}_{k} [ L - {v}_{k} + 2 ] \\ ⋮ \\ {s}_{k} [ L ] \\ 0 \\ ⋮ \\ 0\end{matrix} ] .$$

In this work, we combine the MAI and WGN of (18) into one colored noise vector. Estimating delay of the desired user τ₁ then becomes jointly estimating signal parameters v₁ and γ₁ in colored noise of unknown covariance structure. The colored noise has zero mean and covariance matrix
Q=UA₁²U^{T}+τ²I_{L},
where U=[u₂^{(r)}u₂^{(l)} . . . u_{K}^{(r)}u_{K}^{(l)}], and A₁=I₂\textcircled{×}diag{A₂, A₃, . . . , A_{K}}. Note that the actual structure of the noise covariance matrix depends on the nuisance parameters of all interfering users.

### III. Rank Reduction for Rapid Timing Acquisition

In most communications systems, a fixed preamble (M bits) associated with each user is used for timing acquisition and system synchronization. Then the signal of interest as well as the data model in (18) associated with the preamble bits can be simplified to
r(i)=β₁u₁(τ₁)+e(i), i=1, 2, . . . , M, (20)
where β₁ is an unknown scalar; the signal vector u₁(τ₁)=u₁^{(r)}+u₁^{(l)} is parameterized by delay θ=[v₁γ₁]^{T}; and the colored noise e(i) is of zero mean and unknown covariance, E{e(i)}=0, cov(e(i))=Q. Note that under the Gaussian assumption for the data vectors in (4), the sufficient statistics for estimating all the unknowns, τ₁, β₁ and Q, are functions of the sample mean vector and the sample correlation matrix, i.e.

$$\frac{1}{M} {\sum }_{i = 1}^{M} r ( i ) , \frac{1}{M} {\sum }_{i = 1}^{M} r ( i ) {r}^{T} ( i )$$

Hence, in this work, we use the Gaussian approximation to model the sample mean statistic. That is,

$$\hat{m} = \frac{1}{M} {\sum }_{i = 1}^{M} r ( i ) \sim 𝒩 ( {β}_{1} {u}_{1} ( {τ}_{1} ) , \frac{1}{M} Q ) .$$

This turns out to be a reasonable assumption when the combined effect from M preamble bits and the number of MA users K is large. The delay estimate is then given by [7],

$${\hat{τ}}_{1} = arg {max}_{τ} J ( τ ) = arg {max}_{τ} \frac{{\vert {\hat{m}}^{T} {\hat{Q}}^{- 1} {u}_{1} ( τ ) \vert}^{2}}{{u}_{1}^{T} ( τ ) {\hat{Q}}^{- 1} {u}_{1} ( τ )} , \qquad ( 21 )$$

where

$$\hat{Q} = \frac{1}{M} {\sum }_{i = 1}^{M} r ( i ) {r}^{T} ( i ) - \hat{m} {\hat{m}}^{T}$$

is the sample covariance estimate of the unknown Q matrix. Note that without the Gaussian assumption, the above delay estimate is the non-linear weighted least squares solution for τ₁ in the model of equation (20). Also note that normalizing the objective function J(τ) by a term \hat{m}^{T}\hat{Q}⁻¹\hat{m} (not affecting the delay estimate) leads to the equivalent adaptive coherence estimator (ACE) [9], [10].

In communication applications, the preamble bits are scarce, therefore we propose to use a rank reduction technique to facilitate the rapid timing acquisition. The rank reduction technique from our recent work [5], [6] can alleviate the problem encountered in sample covariance matrix inversion (especially when M<L), yet at the same time to deliver data-driven solutions to low-complexity timing acquisition. In doing so, the rank-r solution to timing acquisition is obtained from,

$${\hat{τ}}_{1} = arg {max}_{τ} {J}^{( r )} ( τ ) ,$$

where the rank-r version of the objective function becomes,

$${J}^{( r )} ( τ ) = \frac{{\vert {\hat{m}}^{T} {w}_{{u}_{1}}^{( τ )} ( τ ) \vert}^{2}}{\vert {u}_{1}^{T} ( τ ) {w}_{{u}_{1}}^{( r )} ( τ ) \vert} . \qquad ( 22 )$$

In (6), the vector wᵤ_{₁}^{(r)}(τ) is a rank-r approximation to the Wiener filter vector defined as wᵤ_{₁}(τ)=\hat{Q}⁻¹u₁(τ). It can be iteratively calculated using the conjugate direction vectors [2], [3], [5],

$${w}_{{u}_{1}}^{( r )} ( τ ) = {\sum }_{i = 1}^{r} {α}_{i} {d}_{i} ∈ {𝒦}_{r} ( \hat{Q} , {u}_{1} ( τ ) ) ,$$

where Kᵣ(\hat{Q}, u₁(τ)) denotes the rank-r Krylov subspace; the vectors dᵢεKᵣ(\hat{Q}, u₁(τ)) are the \hat{Q}-conjugate directions; and the scalars αᵢ=u₁^{T}(τ)dᵢ/dᵢ^{T}\hat{Q}dᵢ are the best linear combination coefficients (the scalar Wiener filters working on the decorrelated internal variables zᵢ=dᵢ^{T}\hat{m}) for the set of r given conjugate direction vectors. Specifically, at the r-th step of iteration, out of the rank-r Krylov subspace Kᵣ(\hat{Q}, u₁(τ)), a rank-r approximation to the Wiener filter is constructed as an optimal linear combination of the r conjugate direction vectors generated by the vector conjugate gradient (V-CG) method. The initial direction vector is chosen as d₁=u₁(τ), and the subsequent direction vectors are chosen as the \hat{Q}-conjugate directions. That is [2, 5], the new direction vectors are updated using the innovation contained in the residue (gradient) vector,

$${d}_{k + 1} = {g}_{k + 1} + \frac{{‖ {g}_{k + 1} ‖}^{2}}{{‖ {g}_{k} ‖}^{2}} {d}_{k} , \qquad ( 23 )$$

where dₖ^{T}\hat{Q}dₘ=0 for k≠m. The residue vector is updated accordingly as
gₖ₊₁=gₖ−αₖ\hat{Q}dₖ, (24)
Note that when the number of available preamble bits M is very small, making the sample covariance matrix \hat{Q} rank deficient (M<L), the proposed reduced-rank version of the objective function can still be calculated using the above procedures. In such cases, we observe from the simulations the advantages of the low-rank timing acquisition scheme over the high-rank solutions.

### IV. Simulation Experiments

The application problem considered in this work is the propagation delay estimation of a desired user in a code-division multiple-access communication environment [7], [8]. In such applications, the presence of multiple-access interference (MAI) from other users renders the conventional correlator based delay estimator useless. As mentioned earlier, we treat the desired user as the signal of interest and other interfering users as interference of unknown covariance structure. Under the condition of the near-Gaussian interference-plus-noise, the maximum likelihood estimate of τ₁ simply corresponds to the maximum of an objective function J(τ₁) in (5) or its scaled version J_{ACE}(τ₁). This estimator is near-far resistant due to the fact that it makes use of the structure of the MAI. In our approximation of this objective function, we use a sample covariance matrix \hat{Q} and an implicit approximation to its inverse, by using a sequence of recursively approximated Krylov subspaces. For the examples used, we choose a multiple access system with K=10 users. The signature length is chosen as L=31. The SNR for the desired user is fixed as SNR(1)=11 dB, and the SNRs for all the interfering users are chosen as SNR(k)=SNR(1)+NFRdB, k=2, . . . , K, with near-far ratio chosen as NFR=0, 10 dB. We vary the number of preamble bits M=10, 20, 31. In all the figures, we show the objective functions at different ranks and different NFRs as a function of delay parameter τ₁. The true delay is marked by a dashed line.

This work demonstrates the applicability of the fast converging reduce-rank Wiener filter to low-complexity data-driven rapid timing acquisition in CDMA systems.

### REFERENCES

[1] J. S. Goldstein, I. S. Reed, and L. L. Scharf, “A Multistage Representation of the Wiener Filter Based on Orthogonal Projections,” IEEE Trans. on Inform. Theory, vol. 44, pp. 2943-2959, November 1998.
[2] M. E. Weippert, J. D. Hiemstra, J. S. Goldstein, and M. D. Zoltowski, “Insights from the Relationship between the Multistage Wiener Filter and the Method of Conjugate Gradients,” Proceedings of the second IEEE Workshop on Sensor Array and Multichannel Signal Processing, Washington, D.C., August 2002.
[3] L. L. Scharf, L. T. McWhorter, E. K. P. Chong, J. S. Goldstein, and M. D. Zoltowski, “Algebraic Equivalence of Conjugate Direction and Multistage Wiener Filters,” Proceedings of the Eleventh Annual Workshop on Adaptive Sensor Array Processing, Lexington, Mass., March 2003.
[4] M. L. Honig, and W. Xiao, “Performance of Reduced-Rank Linear Interference Suppression,” IEEE Trans. on Infor. Theo., vol. 47, pp. 1928-1946, July 2001.
[5] H. Ge, L. L. Scharf, and M. Lundberg, “Reduced-Rank Multiuser Detectors Based on Vactor and Matrix Conjugate Gradient Wiener Filters,” Proc. of the Fifth IEEE Workshop on Signal Processing Advances in Wireless Communications, Portugal, July 2004.
[6] H. Ge, M. Lundberg, and L. L. Scharf, “Warp Convergence in Conjugate Gradient Wiener Filters,” Proc. of the Third IEEE Workshop on Sensor Array and Multichannel Signal Processing, Spain, July 2004.
[7] H. Ge, K. Wang, and K. C. Hong, “Fast Delay Estimation for Asynchronous CDMA Communications Systems,” Proc. of the IEEE Asilomar Conf on Signals, Systems, and Computers pp. 1589-1593, November 1999.
[8] S. E. Bensley and B. Aazhang, “Maximum-Likelihood Synchronization of a Single User for Code-Division Multiple-Access Communication Systems,” IEEE Trans. on Communications, vol. 46, no. 3, pp. 392-399, March, 1998.
[9] L. L. Scharf, and L. T. McWhorter, “Adaptive Matched Subspace Detectors and Adaptive Coherence,” Proc. of the 30th Asilomar Conf on Signals, Systems, and Computers,” Pacific grove, November 1996.
[10] S. Kraut and L. L. Scharf and R. W. Butler “The Adaptive Coherence Estimator: A Uniformly Most-Powerful-Invariant Adaptive Detection Statistic,” IEEE Trans. on Signal Processing, vol. 53, no. 2, pp. 427-438, February 2005.
   Part D—Warp Convergence in Conjugate Direction Wiener Filters

### I. Introduction

Many advanced signal processing systems, ranging from designing linear filters for space-time adaptive processing in radar and sonar systems, to signal separation and interference suppression in communications, involve such filtering operations as s^{T}R_{yy}⁻¹s, and s^{T}R_{yy}⁻¹y, where R_{yy} is the correlation matrix of the measurement vector y, and the vector s denotes the signal mode of interest. For different application scenarios, the signal mode vector can either be parameterized by the temporal/spatial frequency as the mode/steering vector in space-time adaptive processing, or be digitalized as the signature vector in spread spectrum CDMA system. In practice, the dimension, N, of these vectors and matrix involved may be very large. This not only causes the slow convergence during the real-time adaptation of the systems in dynamically changing interference environments, but also causes the performance degradation of the system when only a small number of data samples are available for estimating the data statistics.

In this paper, we study the conjugate direction (CD) methods [1], [2], [3] applied to design reduced-rank (RR) Wiener filter (WF) iteratively for applications in beamforming and communications. At each iteration of the algorithm, a RR WF, that is contained in the expanding Krylov subspace, Kₗ(s, R_{yy}) is constructed. We study cases when the Gram matrix of the signal modes has structures that lead to fast convergence of the CDRR WF. This finding will be useful during the adaptive implementation of the systems for communications and array processing. Examples of computer simulation are provided to demonstrate the remarkable fast convergence property of the CDRR Wiener filters.

### II. Notation and Main Results

Let us assume that the measurement vector y follows a linear model,
y=Sθ+n, (25)
where the matrix S=[s₁s₂ . . . s_{K}] contains signal modes of all sources; the random vector θ=[θ₁θ₂ . . . θ_{K}]^{T} contains information carried by signal modes; the noise vector, n˜N(0, σ²I), is white Gaussian. In this work, we choose mode s₁ as the desired signal mode. The rest of the signal modes, sₖ, (k=2, 3, . . . , K), are treated as interferences. The data correlation matrix R_{yy} has the following structure,

$${R}_{yy} = {SPS}^{T} + {σ}^{2} I = {\sum }_{k = 1}^{K} {P}_{k} {s}_{k} {s}_{k}^{T} + {σ}^{2} I , \qquad ( 26 )$$

where the diagonal matrix P=diag{P₁, P₁, . . . , P_{K}}, with Pₖ=E{|θₖ|²}, contains the power of each uncorrelated sources.

We studied the cases when the Gram matrix of signal modes, Gₛ=S^{T}S, can be decomposed as,

$$\begin{matrix}{G}_{s} = {α}_{0} {I}_{K \times K} + {\sum }_{l = 1}^{L} {α}_{l} {q}_{l} {q}_{l}^{T} , & L \leq K - 1.\end{matrix} \qquad ( 27 )$$

where the (K×1) vectors, qₗ's, are linearly independent of each other. In most of the cases, we have L<<K≦N. This decomposition represents the factors that cause the signal modes to deviate from the perfect orthogonal set. In this work, We have proved that the CDRR Wiener filter,
wₗ^{CDRR}=SₗμₗεRange(Sₗ),
with Sₗ=[s₁,R_{yy}s₁, . . . ,R_{yy}^{l-1}s₁],
converges to the full-rank Wiener filter, w_{WF}=R_{yy}⁻¹s₁, in at most (L+1) steps/iterations, when the powers, Pₖ's, are evenly distributed among all signal modes. This means that in such cases, a rank-(L+1) CDRR WF guarantees to deliver the same performance as that of the full-rank WF. This is due to the fact that at each iteration of CD method, a RR-WF is constructed from the Krylov subspace Kₗ(s₁, R_{yy})=<Sₗ>. Using the R_{yy} in (2), we can explicitly write the equivalent basis vectors of the expanding subspace <Sₗ> as

$$< {S}_{l} > ≡ < {s}_{1} , {\sum }_{k = 1}^{K} {β}_{k}^{( 1 )} {s}_{k} , ⋯ , {\sum }_{k = 1}^{K} {β}_{k}^{( i - 1 )} {s}_{k} > ,$$

where the coefficients βₖ^{(l)}'s depend on signal modes, sₖ's, and their powers, Pₖ's, as well as the noise power σ². For the most general choices of the mode matrix S and the parameters Pₖ's in (26), we have shown earlier [4] that the subspace <Sₗ> stops expanding after l=K-step. This leads to the K-step (at most) convergence results in [4]. However, for some important cases when the Gram matrix satisfies (27), we further show in this work that,
<Sₗ>⊂<s₁,Sq₁, . . . ,Sq_{L}>,∀l.
In other words, for such applications (L+1<<K), we can further reduce the rank/stage down to (L+1) during the construction of the RR-WF using the CD method, yet still deliver the same performance as the full-rank WF.

### III. Application Examples

We present two application scenarios originated from communications and array processing to demonstrate the fast convergence behavior of the CDRR Wiener filters. Other application examples will be included in the full paper.

A. Applications in CDMA Systems

For CDMA applications, columns of S matrix stand for signature vectors (normalized spreading codes) of all active users in the system. When a set of K length-N Gold codes is chosen as spreading codes, we can always decompose the Gram matrix in the form in equation (26). Specifically, when a good set of Gold codes is chosen, we have:

$$\begin{matrix}y = {\sum }_{l = 0}^{g} {\sum }_{m = 0}^{{M}_{l} - 1} {\sum }_{k = 1}^{{K}_{l}} {A}_{k , l} {b}_{k , l} ( m ) {s}_{k , l}^{( m )} + n \\ = \underbrace{{S}_{d} {A}_{d} {b}_{d}}_{desired group} + {\sum }_{l = 0}^{g} {S}_{l} {A}_{l} {b}_{l} + n \\ = SAb + n ,\end{matrix} \qquad ( 28 )$$

where 1 stands for a (K×1) vector of all ones.
When a bad set of Gold codes is chosen, we have:

$$\begin{matrix} {G}_{ S} = \frac{N + 1}{ N} {I}_{K \times K} - \frac{1}{ N} {11}^{ T} + \frac{t}{ N} ( {uv}^{ T} + {vu}^{ T} ) \\ = \frac{N + 1}{ N} {I}_{K \times K} - \frac{1}{ N} {11}^{ T} + \frac{t}{ 2 N} ( {q}_{ 2} {q}_{ 2}^{ T} - {q}_{ 3} {q}_{ 3}^{ T} ) \end{matrix}$$

the constant t is related to the three-value cross-correlation property of Gold codes. The vectors u and v contain only elements drawn from {−1, 0, +1}. The vectors q₂=u+v and q₃=u−v. The presence of terms uv^{T} and vu^{T} is due to the inclusion of the Gold code with bad cross-correlation in the code signature matrix S. The effect of these terms is to sparsely place elements with opposite values t/N and −t/N on the locations above and below the main diagonal of the G. Most importantly, these additional dyad terms present in the Gram matrix Gₛ reveal the factors that cause the non-orthogonality among signal modes. They dictate additional steps needed, in additional to the first stage matched filtering w₁^{(CDRR)}=s₁, for the CD method to converge to the full-rank Wiener solution R⁻¹s₁. This observation implies that under ideal power control, the CDRR WF based multiuser detector (MUD) should converge to its full-rank counterpart within only 2˜4 stages/iterations. Furthermore, we can also design a group-wise power control scheme used for users (using Gold codes) with four different transmission power levels, so that the 4-stage convergence property of the CDRR-WF still holds. Simulation results in FIG. 1 demonstrates the fast convergence results of the CDRR WF used in implementing a multiuser detector (MUD) in CDMA systems with K=10 active users, each using a distinct Gold code of length N=15. We fixed the SNR₁ [symbol] P₁/σ²=11 db for the desired user, and SNRₖ [symbol] Pₖ/σ²=SNR₁+NFR, (k=2, 3, . . . , K) for all interfering users. The near-far-ratio (NFR) is defined as the ratio between Pₖ and P₁ in dB.
B. Applications in Array Signal Processing

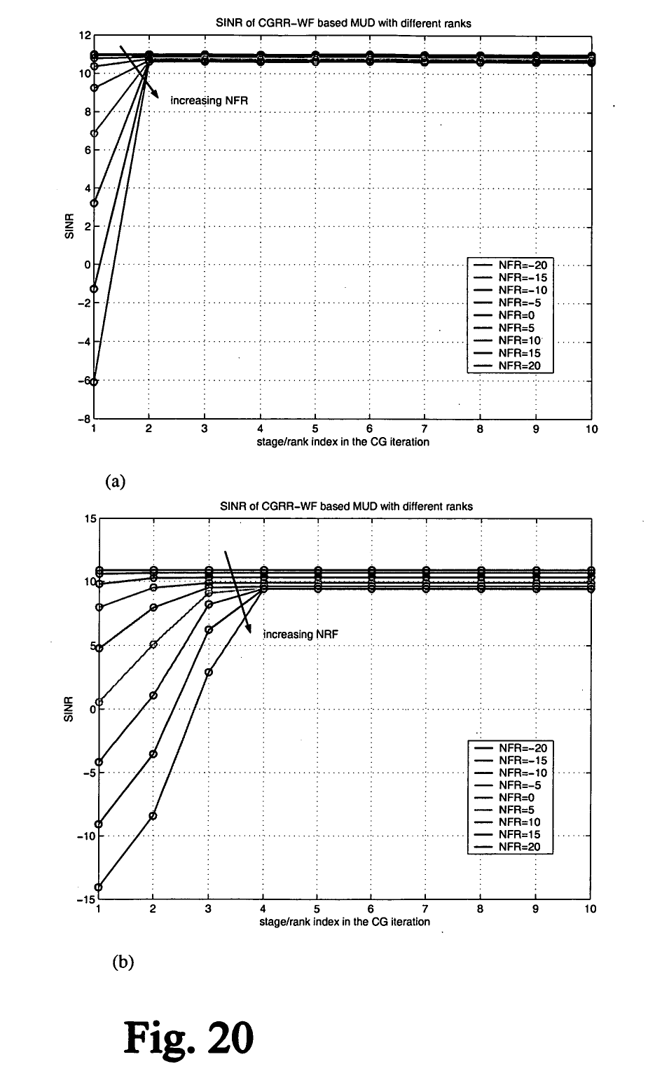

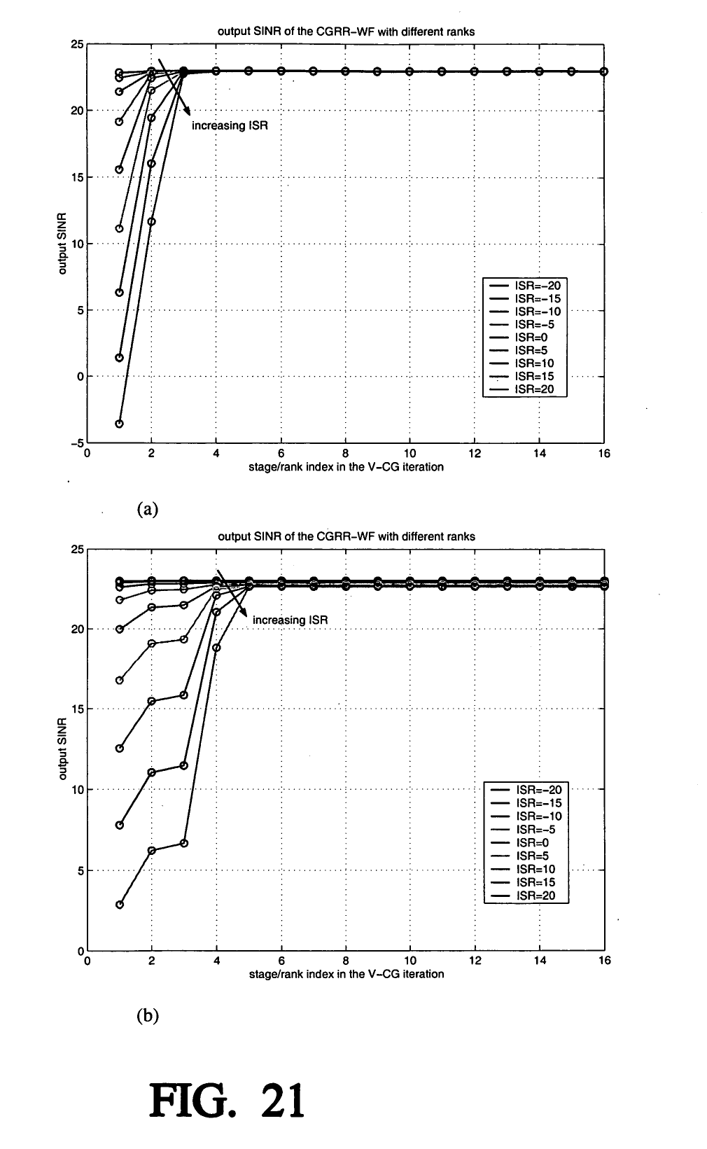

In array processing applications, the output data snapshot from a given N-element uniform linear array (ULA), in response to K signal modes, follows the same model in (25). Here the signal modes (columns of S matrix) are parameterized by the angles of arrival of different sources,
S=[s(v₁)s(v₂) . . . s(v_{K})].
When all the modes are orthogonal, we have s^{H}(vₖ)s(vₗ)=Nδ_{k,l} and G_{S}=NI_{K×K}. However, when the signal of interest, s(v₁), and interfering sources, S(vₖ)'s, (k=2, 3, . . . K), are not allied with the orthogonal modes as we expected, the CDRR WF can be used to filter out the desired signal mode. The L effective dyad terms present at the Gram matrix G_{S} in (27) reflect the net independent factors that cause the non-orthogonal columns of the G_{S}. For many applications, we experience fast and early convergence at the steps (at most L+1) smaller than K, the total number of signal plus interference modes. In FIG. 20, we simulated a case in where there are K=10 spatially distributed far-field sources impinging on a N=16 elements ULA. The source of interest, s(v₁) (marked in red dotted line in FIG. 20(b)) with SNR₁=P₁/σ²=11 is not orthogonal to all interfering sources (marked in green dotted lines in FIG. 20(b)), s(v₂) . . . s(v_{K}). Among K=10 modes, we randomly perturb two modes so that they are not allied with the orthogonal modes. Using the CDRR WF, we expect a convergence being reached in at most L+1=5 steps. FIGS. 20-21 demonstrate the early convergence as expected. Note that the maximum SINR for the desired signal mode is bounded by SINR₁=SNR₁+array gain. Different levels of interference to signal ratio (ISR), SIR=Pₖ/P₁, (k=2, 3, . . . , K) in dB, are chosen.

The same kind of predicable convergence behavior can be observed for other experimental setups, where the spacing between array elements (due to the break-downs of some sensors in the array structure) along with the DOAs of sources makes the Gram of the mode matrix to deviate from the diagonal matrix.

### REFERENCES

[1] M. R. Hestenes and E. Stiefel, “Methods of conjugate gradients for solving linear systems,” J. Res. Nat. Bur. Stand., vol. 49, pp. 409-436, 1952.
[2] L. L. Scharf, L. T. McWhorter, E. K. P. Chong, J. S. Goldstein, and M. D. Zoltowski, “The exact algebraic equivalence of conjugate direction and multistage wiener filters,” 11th Annual MIT Lincoln Labs Workshop on Adaptive Sensor Array Processing, Lexington, Mass., March 2003.
[3] M. E. Weippert, J. D. Hiemstra, J. S. Goldstein, and M. D. Zoltowski, “Insights from the relationship between the multistage wiener filter and the method of conjugate gradients,” Proceedings of the second IEEE Workshop on Sensor Array and Multichannel Signal Processing, August 2002.
[4] H. Ge, L. L. Scharf, and M. Lundberg, “Reduced-rank multiuser detectors based on vector and matrix conjugate gradient Wiener filters,” Proc. of the fifth IEEE Workshop on Signal Processing Advances in Wireless Communications, July 2004.
   Part E—Reduced-Rank Filtering: Complexity and Performance Scalable Multiuser Detectors for Multi-Rate CDMA Systems

Multimedia wireless communication systems need to accommodate a variety of potentially disparate information sources, such as voice, packet data, and video signals. These different information sources have different QoS requirements, which include bit-rate, allowable transmission delay, source priority, and performance measures (the SINR and the BER). In this work, we propose reduced-rank approach [1-4] to reducing the implementation complexity faced by the traditional full-rank multiuser detectors for multi-rate CDMA systems. We study the detection performance of the reduced-rank linear minimum mean squared error (LMMSE) MUD. The motivation for putting emphases on such MUD is based on the fact that the LMMSE MUD (in single-rate CDMA system) not only provides a good compromise between computational simplicity and satisfactory system performance, but also provides the possibility of being implemented adaptively without the need for the signatures of other interfering users except for the desired user. For the multi-rate CDMA systems involving data traffic of different data-rates and QoS requirements, this work proposes the fast converging group-wise reduced-rank MUD for different user groups and studies their performances.

### I. Data Model for Multi-Rate CDMA Systems

We assume that the considered multi-rate CDMA system uses the variable spreading length (VSL) access scheme to handle users of different data-rates. In such a system, users are grouped according to their data rates, and all the users with different data-rates use the signature codes of the same chip-rate but different spreading lengths. Hence, the multi-rate data traffic containing g+1 user groups, over the processing interval of duration T₀ specified by the low-rate (LR) users' symbol interval can be modeled as

$$y ( t ) = \underbrace{{\sum }_{m = 0}^{{M}_{g} - 1} {\sum }_{k = 1}^{{K}_{g}} {A}_{k , g} {b}_{k , g} ( m ) {s}_{k , g} ( t - {mT}_{g} )}_{{K}_{g} HR users} + ⋯ + \underbrace{{\sum }_{k = 1}^{{K}_{0}} {A}_{k , 0} {b}_{k , 0} {s}_{k , 0} ( t )}_{{K}_{0} LR users} + n ( t ) , \\ {iT}_{0} \leq t < ( i + 1 ) {T}_{0} ,$$

where users, each using a distinct signature, are grouped according to their data rates. The waveform s_{k,l}(t) of duration Tₗ is the signature waveform of the k-th user in the l-th group; A_{k,l} and b_{k,l} are the amplitude and BPSK symbol of the user; and n(t) is an AWGN process. The data vector yεR^{N}, obtained at the output of the chip-rate matched filtering and sampling unit, over the processing interval T₀ (the LR users' bit interval) can be formulated in matrix form as

$$\begin{matrix}y = {\sum }_{l = 0}^{g} {\sum }_{m = 0}^{{M}_{l} - 1} {\sum }_{k = 1}^{{K}_{l}} {A}_{k , l} {b}_{k , l} ( m ) {s}_{k , l}^{( m )} + n \\ = \underbrace{{S}_{d} {A}_{d} {b}_{d}}_{desired group} + {\sum }_{l = 0 , l \neq d}^{g} {S}_{l} {A}_{l} {b}_{l} + n \\ = SAb + n ,\end{matrix} \qquad ( 28 )$$

where the matrix Aₗ=I_{M}_{ₗ}\textcircled{×}diag{A_{1,l}, A_{2,l} . . . A_{K}_{ₗ}_{,l}} and the vector bₗ=[bₗ^{T}(0) . . . bₗ^{T}(Mₗ−1)]^{T} contains the amplitudes and the Mₗ-bit BPSK symbol vectors of Kₗ users in the l-th group, respectively. Here, \hat{×} denotes the Kronecker product. Within the processing interval of duration T₀, the Mₗ=T₀/Tₗ bits of data from Kₗ users in the l-th group can be treated as MₗKₗ virtual users's data. The N×MₗKₗ matrix Sₗ contains the effective signature codes for the MₗKₗ virtual users in the group. That is,
Sₗ=[s_{1,l}⁽⁰⁾ . . . s_{K}_{ₗ}_{,l}⁽⁰⁾ . . . s_{1,l}^{(M}^{ₗ}⁻¹⁾ . . . s_{K}_{ₗ}_{,l}^{(M}⁻¹⁾].
The N×Kᵥᵢᵣₜᵤₐₗ signature matrix S contains signatures of all Kᵥᵢᵣₜᵤₐₗ virtual users,
S=[S₀S₁ . . . S_{g}].
where

$${K}_{virtual} = {\sum }_{l = 0}^{g} {M}_{l} {K}_{l} .$$

The real-valued white noise vector, n˜N(0, σ²I_{N}), is assumed Gaussian distributed.

### II. Enabling Techniques for Reduced-Rank MUD

We point out that for multi-rate CDMA systems, there exists additional design freedom for us to exploit in constructing the signature codes with certain desired property for user groups of different data rates and QoS requirements.
For example, given a set of

$$K = {\sum }_{l = 0}^{g} {K}_{l}$$

spreading codes of length L, there exist many different ways of constructing the variable length signature codes for all the Kᵥᵢᵣₜᵤₐₗ virtual users. A straightforward way to construct a signature matrix Sₗ, out of a set of Kₗ spreading codes {s_{1,l}, s_{2,l}, . . . , s_{K}_{ₗ}_{,l}}, for the MₗKₗ virtual users is to use the repetition coding scheme. That is,
Sₗ=I_{M}_{ₗ}\textcircled{×}1_{q}_{ₗ}\textcircled{×}[s_{1,l}s_{2,l} . . . s_{K}_{ₗ}_{,l}],
where qₗ=M_{g}/Mₗ=Tₗ/T_{g}, and N=M_{g}L. More advanced way of constructing Sₗ is to utilize the idea of space-time block codes (STBC), such as the Alamouti code (orthogonal-STBC) and other quasi-orthogonal STBCs to map the L×Kₗ signature [s_{1,l}s_{2,l} . . . s_{K}_{ₗ}_{,l}] into a N×KₗMₗ matrix via redundance embedding and orthogonal subspace formulation,
Sₗ=C(s_{1,l}s_{2,l} . . . s_{K}_{ₗ}_{,l}),
where

$$< {S}_{l} > ≡ < {s}_{1} , {\sum }_{k = 1}^{K} {β}_{k}^{( 1 )} {s}_{k} , ⋯ , {\sum }_{k = 1}^{K} {β}_{k}^{( i - 1 )} {s}_{k} > ,$$

Such additional design freedom comes from the difference in data rates and QoS requirements among different user groups. In section 4, we provide a few specific code design examples for simulation experiments to demonstrate the fast converging features of the MUD.
The general design strategy proposed here is to construct, on a groupwise basis, properly normalized (according to the data rates and QoS requirements) orthogonal or quasi-orthogonal composite signatures out of a given set of spreading codes (typically non-orthogonal) for users in the different data-rate groups. By doing so, we can effectively reduce the number of distinct eigenvalues present in the data covariance matrix R_{yy}, hence, enable the warp convergence [5-6] in the low-complexity reduced-rank MUD.
A. Distributed LMMSE MUD and the RR-MUD

The distributed LMMSE MUD for a desired user, say the user k, decodes the BPSK symbol according to the decision rule,
\hat{b}ₖ=sgn{sₖ^{T}R_{yy}⁻¹y}=sgn{w^{T}y}, (29)
where the N×1 vector sₖ is the signature code of the desired user; and R_{yy}=SA²S^{T}+σ²I is the data covariance matrix. The vector
w=R_{yy}⁻¹sₖ (30)
is the scaled full-rank Wiener filter for the symbol bₖ. Due to the high dimensionality of the system (large N) and the changing dynamics of wireless systems, the reduced-rank solutions of low computational complexity is preferred to the full-rank Wiener filter. Using the concept of expanding (with increasing rank r) Krylov subspaces Kᵣ(R_{yy}, sₖ), we develop a computationally efficient approach [5] to constructing reduced-rank approximations to the full-rank Wiener filter in (30). The approach, stemmed from the vector conjugate gradient (V-CG) method, consists of iterative procedures to construct a sequence of approximations to the full-rank Wiener filter. Specifically, at the r-th step of iteration, out of the rank-r Krylov subspace Kᵣ(R_{yy}, sₖ) a rank-r approximation to the Wiener filter in (30) is constructed as an optimal rank-r linear combination of the r conjugate direction vectors generated by the V-CG method. That is

$${w}_{r} = {\sum }_{i = 1}^{r} {α}_{i} {d}_{i} ∈ {𝒦}_{r} ( {R}_{yy} , {s}_{k} ) , \qquad ( 31 )$$

where vectors dᵢεKᵣ(R_{yy}, sₖ) are the R_{yy}-conjugate directions; and the scalars αᵢ=sₖ^{T}dᵢ/dᵢ^{T}R_{yy}dᵢ are the best linear combination coefficients (the scalar Wiener filters working on the decorrelated internal variables zᵢ=dᵢ^{T}y) for the set of r given conjugate direction vectors.

In our earlier work [5-6], we have shown that there exist the warp convergence (L step convergence, where L<<K≦N) as well as the general convergence (K step convergence) for the V-CG reduced-rank LMMSE MUD. Here by convergence we mean that a reduced-rank MUD delivers the same performance of the full-rank MUD.

B. Centralized LMMSE MUD and the RR-MUD

For the MUD performed at the base stations and relay stations, a centralized solution is desired. In the centralized MUD assuming the knowledge of all active users' signature codes, all the active users' information are decoded in one shot. Therefore, the vector conjugate gradient (V-CG) reduced-rank MUD can be extended into the matrix conjugate gradient (M-CG) MUD using the matrix Wiener filter theory. The centralized LMMSE MUD decodes the symbol vector of all active users according to the decision rule
\hat{b}=sgn{S^{T}R_{yy}⁻¹y}=sgn{W^{T}y}, (32)
where the matrix W=R_{yy}⁻¹S is the scaled matrix Wiener filter for the symbol vector b in (28).

In [5], we have shown that the M-CG MUD converges to its full-rank counterpart in just one step, i.e.
W₁=D₁V₁=R_{yy}⁻¹S,
with columns of the initial direction matrix D₁=S selected as the signature vectors of all the interested users, and the step size matrix V₁=(D₁^{T}R_{yy}D₁)⁻¹G₁^{T}G₁. The initial gradient matrix is chosen as G₁=S.
C. Group-Wise LMMSE MUD in Multi-Rate CDMA

The full-rank matrix Wiener filter for symbol vector b_{d} of the desired group is

$$\begin{matrix}W = {R}_{yy}^{- 1} {S}_{d} , \\ where & ( 33 ) \\ {R}_{yy} = {S}_{d} {A}_{d}^{2} {S}_{d}^{T} + {\sum }_{l = 0 , l \neq d}^{g - 1} {S}_{l} {A}_{l}^{2} {S}_{l}^{T} + {σ}^{2} I . & ( 34 )\end{matrix}$$

The reduced-rank MUD for either a desired user or a desired group of users can be constructed according to the procedures of the vector-CG (V-CG) or the matrix-CG (M-CG), respectively. That is,

$${w}_{r} = {\sum }_{i = 1}^{r} {α}_{i} {d}_{i} , using {d}_{1} = {s}_{k , d} , \\ and$$

$${W}_{r} = {\sum }_{i = 1}^{r} {D}_{i} {V}_{i} , using {D}_{1} = {S}_{d} .$$

Further more, we can use various quasi-orthogonal STBC scheme to construct the composite signature sets (see application examples) to enable partial orthogonality among signature codes in a given user group, so that the M-CG computation can be further reduced due to the subspace decoupling. This will help to speed up the convergence of the reduced-rank MUD in the group-wise MUD. For many application cases, due to the multiplicity relation existed in the data-rates we can construct quasi-orthogonal composite signatures for users in a given group so that the group-wise M-CG MUD constructed from the expanding Krylov subspaces

$${W}_{r} = {\sum }_{i = 1}^{r} {D}_{i} {V}_{i} ∈ {𝒦}_{r} ( {R}_{yy} , {S}_{d} ) , \qquad ( 35 )$$

can be decoupled into pair-wise M-CG MUD with much reduced dimension. The matrices Dᵢ, Vᵢ in (32) contain step-size vectors and direction vectors during the i-th iteration of the M-VG. In addition, we can judiciously control signature code and power allocation among groups of users with various data-rates so that the covariance matrix of the data, on which the group-wise MUD is to be applied, has reduced number of distinct eigenvalues, resulting a warp convergence in the reduced-rank MUD.

### III. Application Examples

Application examples are chosen to demonstrate the fast converging property of the reduced-rank LMMSE MUD for multi-rate CDMA systems. We design a multi-rate CDMA system with variable spreading length sequences to accommodate multi-rate data traffic. We choose a system with the total number of users K=8. There are two user groups among all active users, K₀=4 low-rate (LR) users and K₁=4 high-rate (HR) users. In all examples, we assume that a total of K=8 distinct normalized Gold codes of length L=15 are available for constructing signatures for LR users and HR users. In all examples, we choose to use Gold codes g₁, . . . , g₄ for the LR user group and g₅, . . . , g₈ for the HR user group.
In the first example, we assume that the ratio between the data rates is M=2. Hence, within the processing interval T₀, there are a total of Kᵥᵢᵣₜᵤₐₗ=K₀+MK₁=12 virtual users. Hence, the signature matrices for all the Kᵥᵢᵣₜᵤₐₗ virtual users (including the LR and HR user groups) are constructed respectively according to the O-STBC and repetition coding

$${S}_{0} = {\frac{1}{\sqrt{2 L}} [ \begin{matrix}{g}_{1} & {g}_{2} & {g}_{3} & {g}_{4} \\ - {g}_{2} & {g}_{1} & - {g}_{4} & {g}_{3}\end{matrix} ]}_{2 L ⨯ {K}_{0}}$$

$$and$$

$${S}_{1} = {I}_{2} ⊗ [ \begin{matrix}{g}_{5} & {g}_{6} & {g}_{7} & {g}_{8}\end{matrix} ] .$$

In the second example, we assume that the rate ratio M=4, resulting a total of Kᵥᵢᵣₜᵤₐₗ=K₀+MK₁=20 virtual users. Hence, the signature matrices for all the Kᵥᵢᵣₜᵤₐₗ virtual users (including the LR and HR user groups) are constructed respectively according to the QO-STBC and repetition coding

$${S}_{0} = {\frac{1}{\sqrt{4 L}} [ \begin{matrix}{g}_{1} & {g}_{2} & {g}_{3} & {g}_{4} \\ - {g}_{2} & {g}_{1} & - {g}_{4} & {g}_{3} \\ - {g}_{3} & - {g}_{4} & {g}_{1} & {g}_{2} \\ {g}_{4} & - {g}_{3} & - {g}_{2} & {g}_{1}\end{matrix} ]}_{4 L ⨯ {K}_{0}}$$

$$and$$

$${S}_{1} = {I}_{4} ⊗ [ \begin{matrix}{g}_{5} & {g}_{6} & {g}_{7} & {g}_{8}\end{matrix} ] ,$$

Note that the columns of matrices S₀ and S₁ are all normalized to unity, so that the SNR for a desired user, say user 1, is consistent with the definition of E_{b}/N₀ commonly used in communications. That is, SNR₁=A₁²/σ²=E_{b}/(T_{c}N₀).

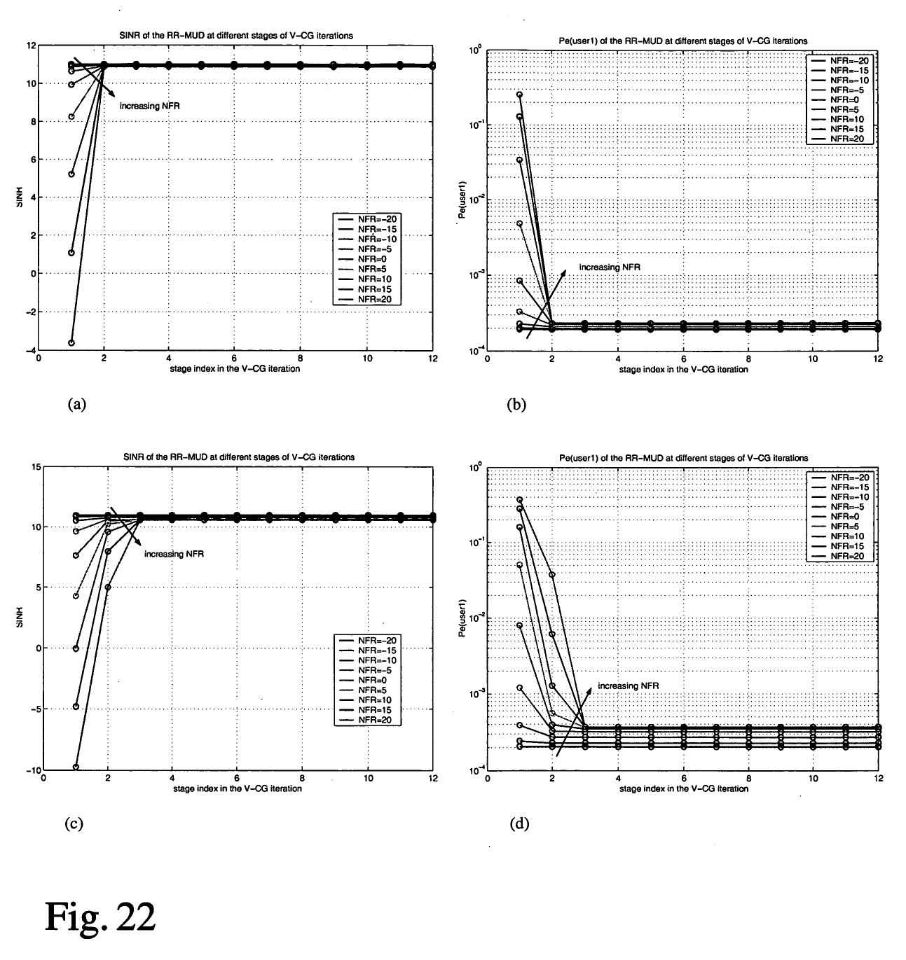

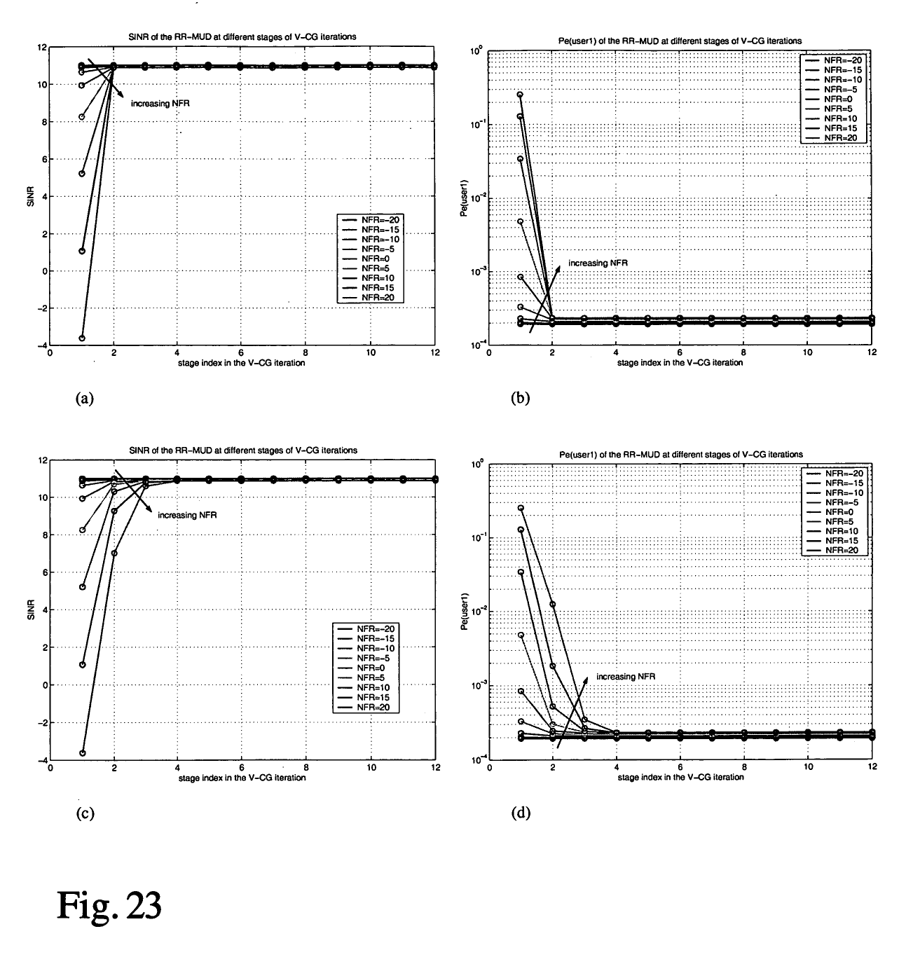

In FIGS. 22 and 23, we use example 1 to show the performance measures of the fast converging reduced-rank LMMSE MUD for a desired LR user and a desired HR user, respectively. In these figures, the SINR and the BER for a desired LR or HR user are plotted at different stages/ranks of iteration of the V-CG, parameterized by different near-far ratio (NFR) setups. System parameters are chosen as N=15, K₀=4, K₁=4, M=2, Kᵥᵢᵣₜᵤₐₗ=12, SNR₁=11 dB, SNRₖ=SNR₁+NFR, (k=2, 3, . . . , K).

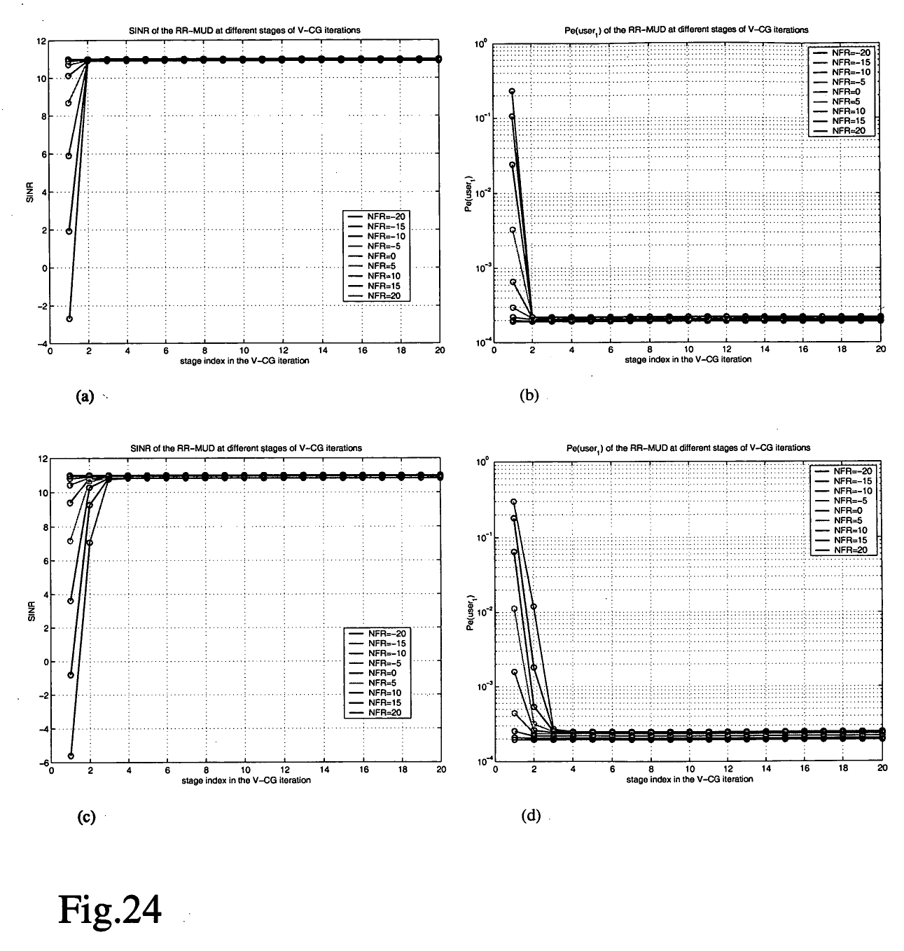

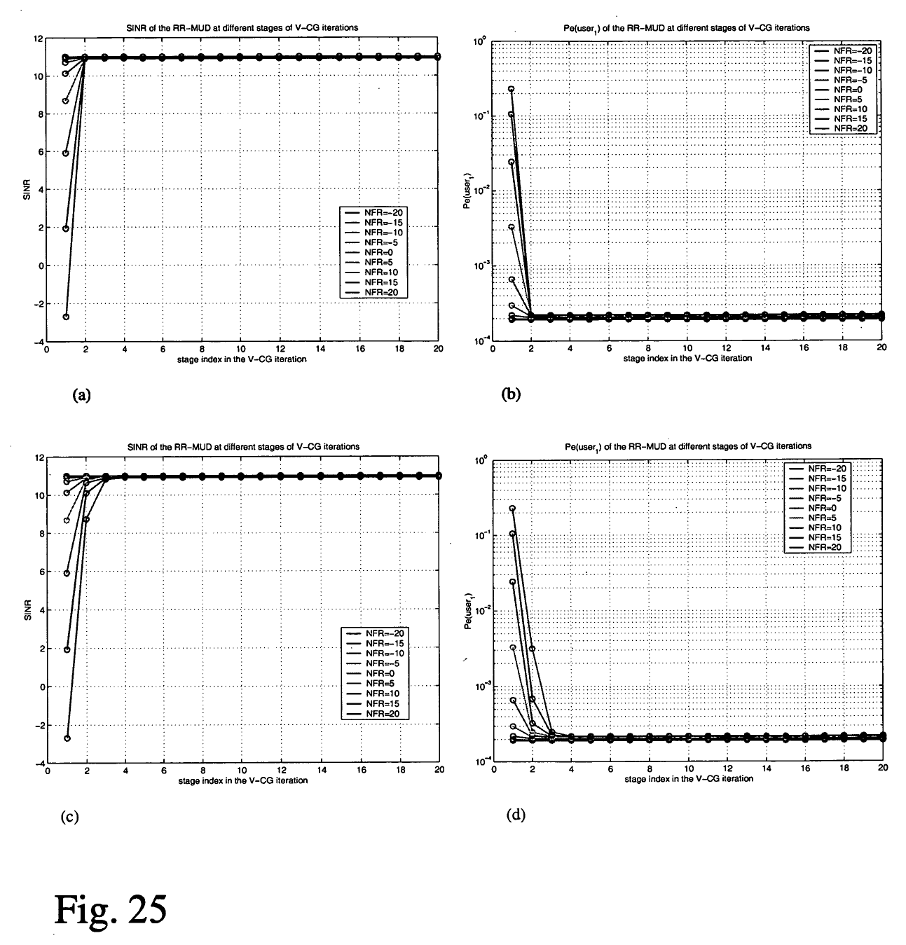

In FIGS. 24 and 25, we use example 2 to show the performance measures of the fast converging reduced-rank LMMSE MUD for a desired LR user and a desired HR user, respectively. In these figures, the SINR and the BER for a desired LR or HR user are plotted at different stages/ranks of iteration of the V-CG, parameterized by different near-far ratio (NFR) setups. System parameters are chosen as N=15, K₀=4, K₁=4, M=4, Kᵥᵢᵣₜᵤₐₗ=20, SNR₁=11 dB, SNRₖ=SNR₁+NFR, (k=2, 3, . . . , K).

In both examples, one can see that rapid convergence occurs much earlier than traditionally predicted by the dimension of the total signal subspace Kᵥᵢᵣₜᵤₐₗ.

### IV. Conclusions

This work demonstrates the applicability of the fast converging reduce-rank LMMSE MUD to multi-rate CDMA systems, involving multi-rate data traffic. Given a set of fixed length spreading codes, through proper design on power allocation schemes along with the construction of composite variable length signature codes we can accommodate different data rates and QoS requirements for different user groups, yet at the same time to enable the warp convergence of the reduced-rank MUD. During the evolution stages of the reduced-rank MUDs, the scalable rank MUDs provide solutions to trade off implementation complexity and satisfying performance.

### REFERENCES

[1] J. S. Goldstein, I. S. Reed, and L. L. Scharf, “A Multistage Representation of the Wiener Filter Based on Orthogonal Projections,” IEEE Trans. on Inform. Theory, vol. 44, pp. 2943-2959, November 1998.
[2] M. E. Weippert, J. D. Hiemstra, J. S. Goldstein, and M. D. Zoltowski, “Insights from the Relationship between the Multistage Wiener Filter and the Method of Conjugate Gradients,” Proceedings of the second IEEE Workshop on Sensor Array and Multichannel Signal Processing, Washington, D.C., August 2002.
[3] L. L. Scharf, L. T. McWhorter, E. K. P. Chong, J. S. Goldstein, and M. D. Zoltowski, “Algebraic Equivalence of Conjugate Direction and Multistage Wiener Filters,” Proceedings of the Eleventh Annual Workshop on Adaptive Sensor Array Processing, Lexington, Mass., March 2003.
[4] M. L. Honig, and W. Xiao, “Performance of Reduced-Rank Linear Interference Suppression,” IEEE Trans. on Information Theory, vol. 47, pp. 1928-1946, July 2001.
[5] H. Ge, L. L. Scharf, and M. Lundberg, “Reduced-Rank Multiuser Detectors Based on Vactor and Matrix Conjugate Gradient Wiener Filters,” Proc. of the Fifth IEEE Workshop on Signal Processing Advances in Wireless Communications, Portugal, July 2004.
[6] H. Ge, M. Lundberg, and L. L. Scharf, “Warp Convergence in Conjugate Gradient Wiener Filters,” Proc. of the Third IEEE Workshop on Sensor Array and Multichannel Signal Processing, Spain, July 2004.
[7] H. Ge, “Multiuser Detection for Integrated Multi-Rate CDMA,” Proc. of the First IEEE International Conf. on Information, Communications and Signal Processing, pp. 858-862, Singapore, September 1997.

What is claimed is:

1. A method for operating a digital modulation communication system to simplify the process of extracting noise and interference from a received signal, the system having at least one transmitter and at least one receiver, the method comprising, in a transmitter:
encoding an input for transmission in said digital modulation communication system with selected spreading codes to produce an encoded input;
adjusting the amplitudes of said spreading codes to produce an encoded, weighted signal said spreading codes and said amplitudes of said encoded input being selected so that said encoded, weighted signal has a correlation matrix with a designed number of distinct eigenvalues; and
transmitting a digitally modulated signal containing said encoded, weighted signal.

2. The method of claim 1, further comprising, in a receiver:
receiving said digitally modulated signal together with noise and interference introduced after transmission; and
extracting said encoded, weighted signal from said noise and interference using a reduced-rank Wiener filter that approximates de-correlation results by using conjugate direction processing having a number of steps that is substantially equal to the designed number of distinct eigenvalues so that said number of steps of said conjugate direction processing can be controlled by selection of said spreading codes and said amplitudes of said spreading codes.

3. A method for providing noise and interference cancellation in a multi-user digital modulation communication system including at least one transmitter and at least one receiver, the method comprising, in a transmitter comprising:
processing a plurality of binary inputs from said multiple users to convert each to a plurality of symbols;
encoding said symbols with good spreading codes to create a plurality of encoded symbols;
adjusting amplitudes of said encoded symbols to produce a plurality of encoded, weighted symbols such that said spreading codes used to encode said symbols and said amplitude of said encoded symbols cause a correlation matrix of said encoded, weighted symbols to have a designed number of distinct eigenvalues;
digitally modulating said encoded, weighted symbols to produce a digitally modulated, encoded weighted signal; and
transmitting said digitally modulated, encoded weighted signal.

4. The method of claim 3, further comprising, at a receiver:
receiving a detected signal composed of a digitally modulated, encoded weighted signal and interference and noise;
demodulating said detected signal; and
filtering said detected signal to substantially remove said interference and noise component using a reduced-rank Wiener filter that approximates de-correlation results by using conjugate direction process that has a number of steps that is substantially equal to the designed number of distinct eigenvalues so that said number of steps of the conjugate direction process can be controlled by selection of said spreading codes and said amplitudes of said spreading codes.

5. In a method for canceling noise and interference in one of passive and active scanning systems, the steps comprising:
encoding an input signal to said active scanning system into encoding symbols and with good space-time codes to create a good transmit signal;
the amplitudes of said plurality of encoding symbols being adjusted to produce said space-time codes so that said good transmit signal has a correlation matrix with a designed number of distinct eigenvalues; and
utilizing the small number of distinct eigenvalues in a passive system;

6. The method of claim 5, further comprising:
generating a reduced-rank Wiener filter steering vector for beam forming, detection, or estimation, the Wiener filter approximating de-correlation results by using a conjugate direction process having a number of steps that is substantially equal to said designed and utilized number of distinct eigenvalues so that the number of steps of said conjugate direction process can be controlled in active scanning by selection of said good space-time codes and said amplitudes of said symbols, and utilized in passive scanning; and
applying said reduced-rank Wiener filter steering vector to signals received by a space-time receiver of said scanning system to cancel interference and noise from a received signal containing the transmit signal.

7. Apparatus for operating a digital modulation communication system to simplify the process of extracting noise and interference from a received signal, comprising:
an encoder encoding an input for transmission in said digital modulation communication system with selected spreading codes to produce an encoded input;
an adjuster adjusting the amplitudes of said spreading codes to produce an encoded, weighted signal said spreading codes and said amplitudes of said encoded input being selected so that said encoded, weighted signal has a correlation matrix with a designed number of distinct eigenvalues; and
a transmitter transmitting a digitally modulated signal containing said encoded, weighted signal.

8. The apparatus of claim 7, further comprising, in a receiver:
a receiver receiving said digitally modulated signal together with noise and interference introduced after transmission; and
an extractor extracting said encoded, weighted signal from said noise and interference using a reduced-rank Wiener filter that approximates de-correlation results by using conjugate direction processing having a number of steps that is substantially equal to the designed number of distinct eigenvalues so that said number of steps of said conjugate direction processing can be controlled by selection of said spreading codes and said amplitudes of said spreading codes.

9. Apparatus for providing noise and interference cancellation in a multi-user digital modulation communication system, comprising:
a processor processing a plurality of binary inputs from said multiple users to convert each to a plurality of symbols;
an encoder encoding said symbols with good spreading codes to create a plurality of encoded symbols;
an adjuster adjusting amplitudes of said encoded symbols to produce a plurality of encoded, weighted symbols such that said spreading codes used to encode said symbols and said amplitude of said encoded symbols cause a correlation matrix of said encoded, weighted symbols to have a designed number of distinct eigenvalues;
a modulator digitally modulating said encoded, weighted symbols to produce a digitally modulated, encoded weighted signal; and
a transmitter transmitting said digitally modulated, encoded weighted signal.

10. The apparatus of claim 9, further comprising:
a receiver receiving a detected signal composed of a digitally modulated, encoded weighted signal and interference and noise;
a demodulator demodulating said detected signal; and
a filter filtering said detected signal to substantially remove said interference and noise component using a reduced-rank Wiener filter that approximates de-correlation results by using conjugate direction process that has a number of steps that is substantially equal to the designed number of distinct eigenvalues so that said number of steps of the conjugate direction process can be controlled by selection of said spreading codes and said amplitudes of said spreading codes.

11. In an apparatus for canceling noise and interference in one of passive and active scanning systems, the combination of:
an encoder encoding an input signal to said active scanning system into encoding symbols and with good space-time codes to create a good transmit signal;
an adjuster adjusting the amplitudes of said plurality of encoding symbols to produce said space-time codes so that said good transmit signal has a correlation matrix with a designed number of distinct eigenvalues; and
a link proving the small number of distinct eigenvalues to a passive system;

12. The apparatus of claim 11, further comprising:
a generator generating a reduced-rank Wiener filter steering vector for beam forming, detection, or estimation, the Wiener filter approximating de-correlation results by using a conjugate direction process having a number of steps that is substantially equal to said designed and utilized number of distinct eigenvalues so that the number of steps of said conjugate direction process can be controlled in active scanning by selection of said good space-time codes and said amplitudes of said symbols, and utilized in passive scanning; and
a further link applying said reduced-rank Wiener filter steering vector to signals received by a space-time receiver of said scanning system to cancel interference and noise from a received signal containing the transmit signal.
